(19) United States
(12) Patent Application Publication
(10) Pub. No.: US 2008/0224533 A1
(43) Pub. Date: Sep. 18, 2008

(54) BRAKE CONTROL APPARATUS AND PROCESS OF CONTROLLING THE SAME

(75) Inventors: Yuki Nakada, Atsugi-shi (JP); Katsuya Iwasaki, Isehara-shi (JP); Koji Takahashi, Atsugi-shi (JP); Yoshitaka Sugiyama, Schwaig-Oberding (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/049,459

(22) Filed: Mar. 17, 2008

(30) Foreign Application Priority Data
Mar. 17, 2007 (JP) 2007-069674

(51) Int. Cl. B60T 13/16; B60T 13/66

(52) U.S. Cl. 303/10; 303/15; 303/20

(57) ABSTRACT

A brake control apparatus for a vehicle includes a wheel cylinder, a pump for pressurizing a brake fluid in the wheel cylinder, and an electric motor for driving the pump. A controller operates the electric motor so as to conform an internal pressure of the wheel cylinder to a desired internal pressure of the wheel cylinder, and produces a torque applied to the electric motor in a first rotational direction, while the pump is stopping from a state in which the electric motor is rotating in a second rotational direction opposite to the first rotational direction so as to allow the pump to pressurize the brake fluid in the wheel cylinder.

### BACKGROUND OF THE INVENTION

The present invention relates generally to brake control apparatuses for wheeled vehicles, and more particularly to brake control apparatuses with a brake-by-wire system for controlling the internal pressures of wheel cylinders so as to produce braking efforts.

Japanese Patent Application Publication No. 2000-130350 discloses a brake control apparatus in which fluid communication between a brake pedal and wheel cylinders is blocked, and wheel cylinder pressures are controlled by computing desired wheel cylinder pressures on the basis of data signals from a brake pedal stroke sensor and a master cylinder pressure sensor, and operating an electric motor for driving a hydraulic pump and electromagnetic valves in accordance with the computed desired wheel cylinder pressures. Specifically, during control of the electric motor, this brake control apparatus computes an increase in a motor drive current, ΔI, using an equation of (ΔI=C1·(P_{WCNM}−P_{WCAC})+C2·ΔP_{WCNM}) where P_{WCAC} represents an actual wheel cylinder pressure, P_{WCNM} represents a desired wheel cylinder pressure, and C1 and C2 represent constant coefficients.

### SUMMARY OF THE INVENTION

According to the brake control apparatus of Japanese Patent Application Publication No. 2000-130350, it is possible, for example, that after a request for rapidly stopping the hydraulic pump is issued, the hydraulic pump continues to rotate for a relatively long period of time due to the inertia of the electric motor, the hydraulic pump, and the operating fluid, even if the motor drive current is quickly reduced after the request is issued. This may cause the wheel cylinder pressures to overshoot desired wheel cylinder pressures.

In view of the foregoing, it is desirable to provide a brake control apparatus capable of more accurately controlling a hydraulic pump so as to minimize an overshoot of a wheel cylinder pressure, and a process of controlling the same.

According to one aspect of the present invention, a brake control apparatus comprises: a wheel cylinder adapted to a wheel of a vehicle; a pump arranged to pressurize a brake fluid in the wheel cylinder; an electric motor arranged to drive the pump; and a controller configured to operate the electric motor so as to conform an internal pressure of the wheel cylinder to a desired internal pressure of the wheel cylinder, the controller being configured to produce a torque applied to the electric motor in a first rotational direction, while carrying out a transition from a first operating state to a second operating state, the first operating state being an operating state that the electric motor is rotating in a second rotational direction opposite to the first rotational direction so as to allow the pump to pressurize the brake fluid in the wheel cylinder, the second operating state being an operating state that a discharge pressure of the pump is lower than in the first operating state. The controller may be configured to produce a torque applied to the electric motor in the first rotational direction, while the pump is stopping from a state in which the electric motor is rotating in the second rotational direction so as to allow the pump to pressurize the brake fluid in the wheel cylinder. The controller may be configured to produce a torque applied to the electric motor in the first rotational direction, while carrying out a transition from a first operating state to a second operating state, the first operating state being an operating state that the electric motor is rotating in the second rotational direction so as to allow the pump to increase the internal pressure of the wheel cylinder at a first rate of change with respect to time, the second operating state being an operating state that the electric motor is rotating in the second rotational direction so as to allow the pump to increase the internal pressure of the wheel cylinder at a second rate of change with respect to time, the second rate being lower than the first rate.

According to another aspect of the present invention, a brake control apparatus comprises: a wheel cylinder adapted to a wheel of a vehicle; a pump arranged to pressurize a brake fluid in the wheel cylinder; an electric motor arranged to drive the pump; a pressure-regulator arranged to regulate an internal pressure of the wheel cylinder; and a controller configured to operate the electric motor so as to conform the internal pressure of the wheel cylinder to a desired internal pressure of the wheel cylinder, the controller being configured to reduce the internal pressure of the wheel cylinder by the pressure-regulator, when the electric motor is rotating so as to allow the pump to pressurize the brake fluid in the wheel cylinder.

According to a further aspect of the present invention, a process of controlling a brake control apparatus including: a wheel cylinder adapted to a wheel of a vehicle; a pump arranged to pressurize a brake fluid in the wheel cylinder; and an electric motor arranged to drive the pump, comprises: operating the electric motor so as to conform an internal pressure of the wheel cylinder to a desired internal pressure of the wheel cylinder; and producing a torque applied to the electric motor in a first rotational direction, while the pump is stopping from a state in which the electric motor is rotating in a second rotational direction opposite to the first rotational direction so as to allow the pump to pressurize the brake fluid in the wheel cylinder.

### BRIEF DESCRIPTION OF THE DRAWINGS

FIG. 1 is a system configuration diagram of an automotive vehicle with a brake control apparatus according to a first embodiment of the present invention.

FIG. 2 is a hydraulic circuit diagram of a hydraulic unit in the brake control apparatus according to the first embodiment.

FIG. 3 is a flow chart showing a control process of controlling wheel cylinder pressures to be performed by a control unit in the brake control apparatus according to the first embodiment.

FIG. 4 is a block diagram showing a detailed configuration of a pump control unit in the control unit according to the first embodiment.

FIG. 5 is a graphic diagram showing an example of waveforms of three-phase drive currents applied to a direct current brushless motor.

FIG. 6 is a diagram showing a relationship between three-phase motor drive alternating currents in a stationary coordinate system and a corresponding two-axis motor drive direct currents in a rotating coordinate system.

FIG. 7 is a block diagram showing a detailed configuration of a motor current control section of the pump control unit according to the first embodiment.

FIG. 8 is a flow chart showing a main control process of motor vector control to be performed by the control unit according to the first embodiment.

FIG. 9 is a flow chart showing a detailed control process to be performed by a desired motor current computing part of the motor current control section of the pump control unit according to the first embodiment.

FIG. 10 is a graphic diagram showing a relationship between a desired motor output torque and a desired motor torque current, which is employed by the desired motor current computing part of the motor current control section of the pump control unit according to the first embodiment.

FIG. 11 is a flow chart showing a detailed control process to be performed by a UVW to dq coordinate transformation part of the motor current control section of the pump control unit according to the first embodiment.

FIG. 12 is a control block diagram showing a control system of a PI control part of the motor current control section of the pump control unit according to the first embodiment.

FIG. 13 is a flow chart showing a detailed control process to be performed by the PI control part of the motor current control section of the pump control unit according to the first embodiment.

FIG. 14 is a flow chart showing a detailed control process to be performed by a dq to UVW coordinate transformation part of the motor current control section of the pump control unit according to the first embodiment.

FIG. 15 is a flow chart showing a detailed control process to be performed by a PWM output part of the motor current control section of the pump control unit according to the first embodiment.

FIG. 16 is a table diagram showing a limiting operation to be performed by the PWM output part of the motor current control section of the pump control unit according to the first embodiment.

FIG. 17 is a schematic circuit diagram showing a detailed configuration of the PWM output part of the motor current control section of the pump control unit according to the first embodiment.

FIG. 18 is a diagram showing a pattern of FET drive signals to be employed by the PWM output part of the motor current control section of the pump control unit according to the first embodiment.

FIGS. 19A and 19B are diagrams showing a relationship between the desired motor torque current and the three-phase motor drive alternating currents.

FIG. 20 is a graphic diagram showing an example of how a pump discharge pressure changes with time under control of pressure increase in a comparative example.

FIG. 21 is a graphic diagram showing an example of how a pump discharge pressure changes with time under control of pressure increase in the first embodiment.

FIG. 22 is a graphic diagram showing an example of how a motor speed changes with time in the comparative example.

FIG. 23 is a graphic diagram showing an example of how a motor speed changes with time in the first embodiment.

FIG. 24 is a graphic diagram showing an example of how a front left wheel cylinder pressure changes with time under control of ABS in the comparative example.

FIG. 25 is a graphic diagram showing an example of how a front left wheel cylinder pressure changes with time under control of ABS in the first embodiment.

FIG. 26 is a graphic diagram showing an example of how the motor speed changes with time under control of ABS in the comparative example.

FIG. 27 is a graphic diagram showing an example of how the motor speed changes with time under control of ABS in the first embodiment.

FIG. 28 is a hydraulic circuit diagram of a hydraulic unit in a brake control apparatus according to a third embodiment of the present invention.

FIG. 29 is a hydraulic circuit diagram of a hydraulic unit in a brake control apparatus according to a fourth embodiment of the present invention.

FIG. 30 is a hydraulic circuit diagram of a hydraulic unit in a brake control apparatus according to a fifth embodiment of the present invention.

FIG. 31 is a system configuration diagram of an automotive vehicle with a brake control apparatus according to a sixth embodiment of the present invention.

FIG. 32 is a hydraulic circuit diagram of a hydraulic unit in the brake control apparatus according to the sixth embodiment.

FIG. 33 is a hydraulic circuit diagram of a hydraulic unit in a brake control apparatus according to a is modification of the sixth embodiment.

FIG. 34 is a system configuration diagram of an automotive vehicle with a brake control apparatus according to a seventh embodiment of the present invention.

FIG. 35 is a hydraulic circuit diagram of a first hydraulic unit in the brake control apparatus according to the seventh embodiment.

FIG. 36 is a hydraulic circuit diagram of a second hydraulic unit in the brake control apparatus according to the seventh embodiment.

FIG. 37 is a system configuration diagram of an automotive vehicle with a brake control apparatus according to an eighth embodiment of the present invention.

FIG. 38 is a hydraulic circuit diagram of a first hydraulic unit in the brake control apparatus according to the eighth embodiment.

FIG. 39 is a hydraulic circuit diagram of a second hydraulic unit in the brake control apparatus according to the eighth embodiment.

### DETAILED DESCRIPTION OF THE INVENTION

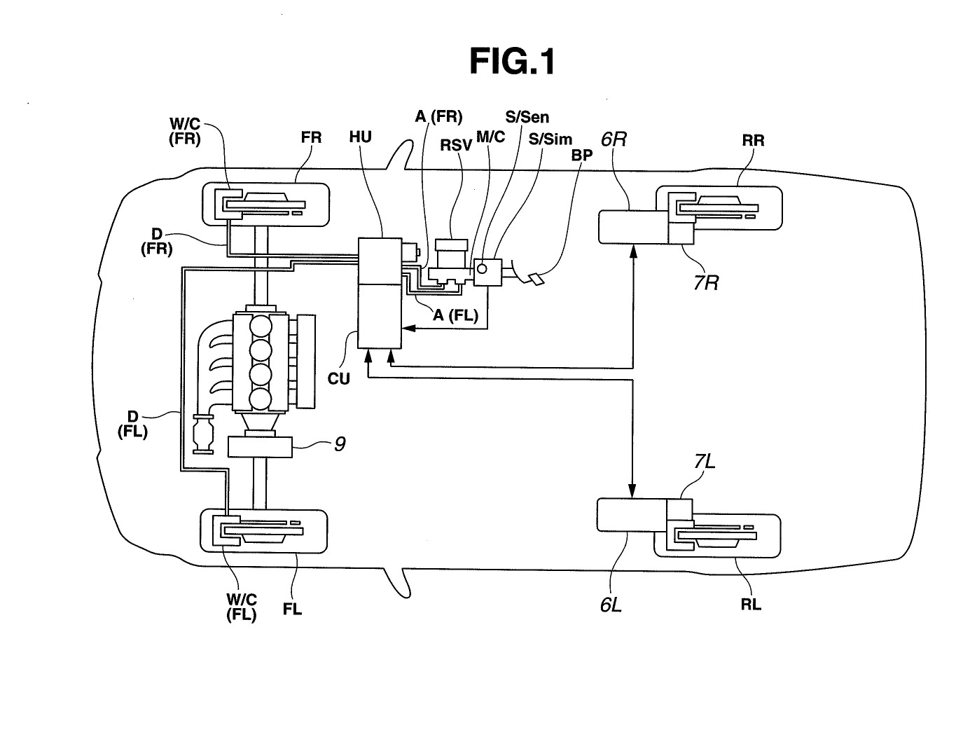

The following describes a brake control apparatus according to a first embodiment of the present invention with reference to FIGS. 1 to 27. FIG. 1 shows a system configuration of an automotive vehicle with the brake control apparatus according to the first embodiment. As shown in FIG. 1, this brake control apparatus includes a hydraulic brake-by-wire system adapted only to front left and right wheels “FL” and “FR” for producing braking efforts based on a pump discharge pressure in which a single hydraulic unit “HU” controls front left and right wheel cylinder pressures “Pfl” and “Pfr”. The brake control apparatus further includes a control unit (or controller) “CU” for controlling the hydraulic unit HU. The brake-by-wire system includes a single piping system and a single electric system with a fail-safe function. Rear left and right wheels “RL” and “RR” are provided with an electric brake system with no hydraulic system for electrically producing braking efforts.

A master cylinder “M/C” is provided with a stroke sensor “S/Sen” and a stroke simulator “S/Sim”. When depressed, a brake pedal “BP” generates a hydraulic pressure in master cylinder M/C. Simultaneously, stroke sensor S/Sen outputs a stroke signal “S” to control unit CU, where the stroke signal S is indicative of the stroke of brake pedal BP. Master cylinder M/C supplies a hydraulic pressure to hydraulic unit HU through fluid passages “A(FL)” and “A(FR)”. Control unit CU controls hydraulic unit HU so as to supply controlled hydraulic pressures through fluid passages “D(FL)” and “D(FR)” to front left and right wheel cylinders “W/C(FL)” and “W/C(FR)”, respectively. Front left and right wheel cylinders W/C(FL) and W/C(FR) are adapted to front left and right wheels FL and FR, respectively.

Control unit CU computes desired front left and right wheel cylinder pressures “P*fl” and “P*fr”, and controls hydraulic unit HU so as to control the internal pressures of front left and right wheel cylinders W/C(FL) and W/C(FR). The brake control apparatus includes a regenerative braking unit 9 in addition to the hydraulic braking system, for applying additional or alternative braking efforts to front left and right wheels “FL” and “FR”. The brake control apparatus includes rear left and right brake actuators “6L” and “6R” configured to receive control signals from control unit CU, and to control the braking efforts of rear left and right electric brake calipers “7L” and “7R”, respectively.

When the brake-by-wire system is operating under normal operating conditions, control unit CU controls hydraulic unit HU so as to keep front left and right wheel cylinders W/C(FL) and W/C(FR) hydraulically separated from master cylinder M/C. Instead of master cylinder M/C, a hydraulic pump “P” pressurizes a brake fluid in front left and right wheel cylinders W/C(FL) and W/C(FR). Provided in hydraulic unit HU, hydraulic pump P supplies hydraulic pressures to front left and right wheel cylinders W/C(FL) and W/C(FR) so as to produce braking efforts. Hydraulic unit HU includes control valves for pressure reduction, and as appropriate, suitably controls the control valves so as to reduce the internal pressures of front left and right wheel cylinders W/C(FL) and W/C(FR), and thereby to prevent front left and right wheels FL and FR from locking. When the brake-by-wire system is failed, control unit CU controls hydraulic unit HU to supply the master cylinder pressure to front left and right wheel cylinders W/C(FL) and W/C(FR) so as to produce braking efforts.

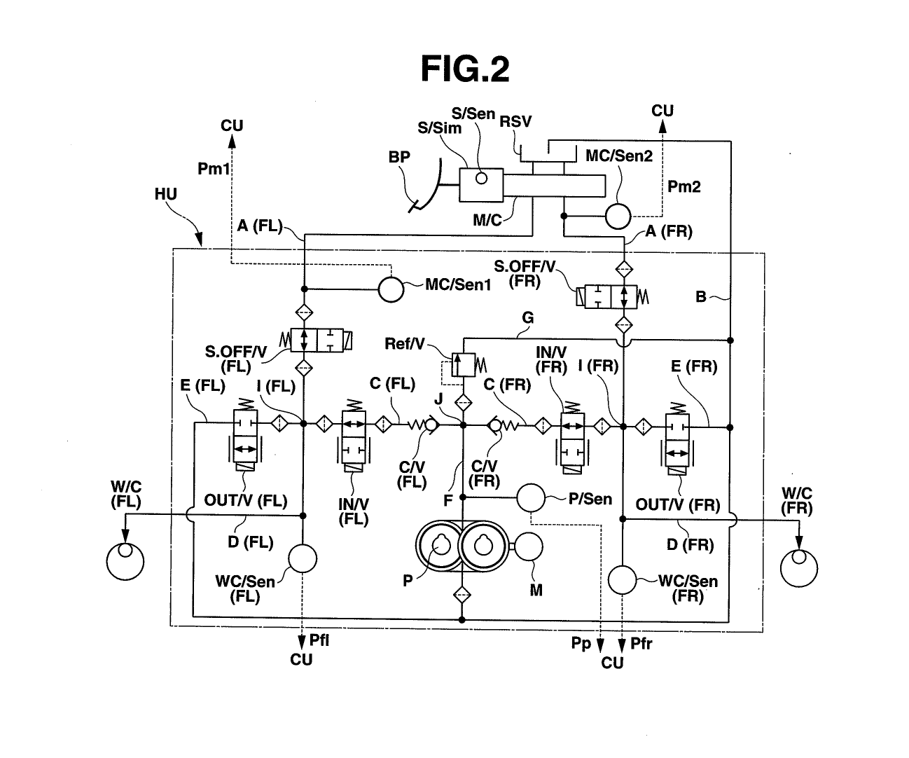

The following describes the hydraulic circuit of hydraulic unit HU in detail with reference to FIG. 2. Hydraulic pump P includes a discharge port hydraulically connected to a fluid passage “F”. Fluid passage F is connected through fluid passages “C(FL)” and “D(FL)” to front left wheel cylinder W/C(FL) and hydraulically connected through fluid passages “C(FR)” and “D(FR)” to front right wheel cylinder W/C(FR). Hydraulic pump P includes a suction port hydraulically connected through a fluid passage “B” to a reservoir “RSV”. Fluid passages C(FL) and C(FR) are hydraulically connected to fluid passage B through fluid passages “E(FL)” and “E(FR)”, respectively.

A node “I(FL)” between fluid passages C(FL) and E(FL) is hydraulically connected through fluid passage A(FL) to master cylinder M/C, while a node “I(FR)” between fluid passages C(FR) and E(FR) is hydraulically connected through fluid passage A(FR) to master cylinder M/C. A node “J” between fluid passages C(FL) and C(FR) is hydraulically connected through a fluid passage “G” to fluid passage B.

A shut-off valve “S.OFF/V(FL)” is disposed in fluid passage A(FL) for selectively allowing or shutting off fluid communication between master cylinder M/C and node I(FL), while a shut-off valve “S.OFF/V(FR)” is disposed in fluid passage A(FR) for selectively allowing or shutting off fluid communication between master cylinder M/C and node I(FR). Shut-off valves S.OFF/V(FL) and S.OFF/V(FR) are normally open electromagnetic valves.

A front left inlet valve (or front left pressure-increasing valve) “IN/V(FL)” is disposed in fluid passage C(FL) for continuously variably regulating the discharge pressure supplied from hydraulic pump P and supplying the regulated hydraulic pressure to front left wheel cylinder W/C(FL), while a front right inlet valve (or front right pressure-increasing valve) “IN/V(FR)” is disposed in fluid passage C(FR) for continuously variably regulating the discharge pressure supplied from hydraulic pump P and supplying the regulated hydraulic pressure to front right wheel cylinder W/C(FR). Front left and right inlet valves IN/V(FL) and IN/V(FR) are normally open linear electromagnetic valves for allowing fluid communication between hydraulic pump P and respective ones of front left and right wheel cylinders W/C(FL) and W/C(FR) with respective variable cross-sectional flow areas. A check valve (unidirectional valve) “C/V(FL)” is disposed in fluid passage C(FL) and hydraulically connected between front left inlet valve IN/V(FL) and node J for preventing brake fluid from inversely flowing from front left inlet valve IN/V(FL) to hydraulic pump P, while a check valve “C/V(FR)” is disposed in fluid passage C(FR) and hydraulically connected between front right inlet valve IN/V(FR) and node J for preventing brake fluid from inversely flowing from front right inlet valve IN/V(FR) to hydraulic pump P.

A front left outlet valve (or front left pressure-reducing valve) “OUT/V(FL)” is disposed in fluid passage E(FL) for continuously variably regulating the hydraulic pressure exiting from front left wheel cylinder W/C(FL), while a front right outlet valve (or front right pressure-reducing valve) “OUT/V(FR)” is disposed in fluid passage E(FR) for continuously variably regulating the hydraulic pressure exiting from front right wheel cylinder W/C(FR). Front left and right outlet valves OUT/V(FL) and OUT/V(FR) are normally closed linear electromagnetic valves. A relief valve “Ref/V” is disposed in fluid passage G between node J and fluid passage B.

A first master cylinder pressure sensor “MC/Sen1” is disposed in fluid passage A(FL) between master cylinder M/C and shut-off valve S.OFF/V(FL) for outputting a data signal to control unit CU, where the data signal is indicative of a first measured master cylinder pressure Pm1. Similarly, a second master cylinder pressure sensor “MC/Sen2” is disposed in fluid passage A(FR) between master cylinder M/C and shut-off valve S.OFF/V(FR) for outputting a data signal to control unit CU, where the data signal is indicative of a second measured master cylinder pressure Pm2.

A front left wheel cylinder pressure sensor “WC/Sen(FL)” is disposed in fluid passage D(FL) in hydraulic unit HU for measuring the internal pressure of front left wheel cylinder W/C(FL), and outputting a data signal to control unit CU, where the data signal is indicative of a front left wheel cylinder pressure “Pfl”. Similarly, a front right wheel cylinder pressure sensor “WC/Sen(FR)” is disposed in fluid passage D(FR) in hydraulic unit HU for measuring the internal pressure of front right wheel cylinder W/C(FR), and outputting a data signal to control unit CU, where the data signal is indicative of a front right wheel cylinder pressure “Pfr”. Moreover, a pump discharge is pressure sensor “P/Sen” is disposed in fluid passage F on the discharge side of hydraulic pump P for outputting a data signal to control unit CU, where the data signal is indicative of a pump discharge pressure “Pp”.

Hydraulic pump P is driven by an electric motor “M”. Control unit CU is basically configured to perform wheel cylinder pressure control of operating the electric motor M and the control valves so as to conform the measured internal pressures of the wheel cylinders to respective ones of desired internal pressures of the wheel cylinders.

Under normal operating conditions, the brake-by-wire system of the brake control apparatus operates basically as follows. When it is desired to increase the hydraulic pressure of front left wheel cylinder W/C(FL), control unit CU controls hydraulic unit HU by closing the shut-off valve S.OFF/V(FL), opening the front left inlet valve IN/V(FL), driving the electric motor M, and controlling the opening of front left inlet valve IN/V(FL), so as to increase the hydraulic pressure of front left wheel cylinder W/C(FL). When it is desired to reduce the hydraulic pressure of front left wheel cylinder W/C(FL), control unit CU controls hydraulic unit HU by closing the front left inlet valve IN/V(FL), opening the front left outlet valve OUT/V(FL), so as to drain the hydraulic pressure from front left wheel cylinder W/C(FL) to reservoir RSV. When it is desired to hold constant the hydraulic pressure of front left wheel cylinder W/C(FL), control unit CU controls hydraulic unit HU by closing the front left inlet valve IN/V(FL) and closing the front left outlet valve OUT/V(FL), so as to hold the hydraulic pressure of front left wheel cylinder W/C(FL). The hydraulic pressure of front right wheel cylinder W/C(FR) is similarly controlled by control unit CU.

While the brake control apparatus is operating in manual braking mode, control unit CU controls hydraulic unit HU by allowing the shut-off valves S.OFF/V(FL) and S.OFF/V(FR) and front left and right inlet valves IN/V(FL) and IN/V(FR) to be normally open, and allowing the front left and right outlet valves OUT/V(FL) and OUT/V(FR) to be normally closed, so as to supply a master cylinder pressure “Pm” to front left and right wheel cylinders W/C(FL) and W/C(FR). This allows to control mechanically the braking efforts.

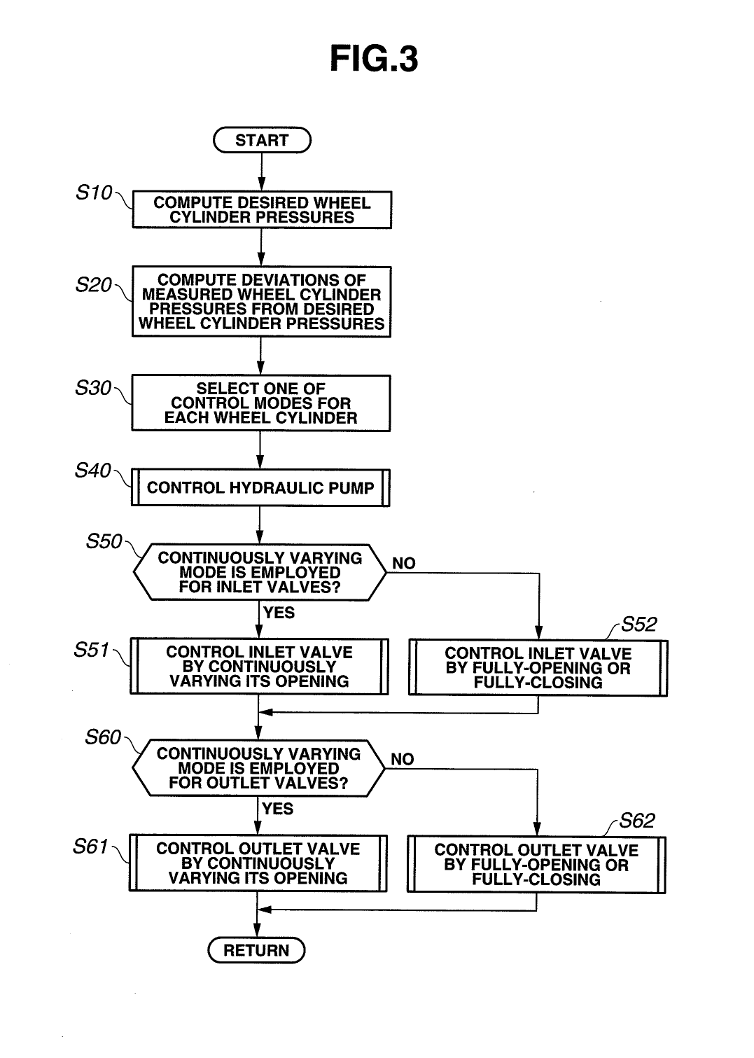

The following describes a control process of hydraulic pressure control to be performed by control unit CU with reference to FIG. 3. Control unit CU operates as follows.

At Step S10, control unit CU sets or computes desired front left and right wheel cylinder pressures P*fl and P*fr of front left and right wheel cylinders W/C(FL) and W/C(FR), and then proceeds to Step S20.

At Step S20, control unit CU computes a deviation ΔPfl between actual front left wheel cylinder pressure Pfl and desired front left wheel cylinder pressure P*fl, and a deviation ΔPfr between actual front right wheel cylinder pressure Pfr and desired front right wheel cylinder pressure P*fr, and then proceeds to Step S30.

At Step S30, control unit CU select one of control modes on the basis of deviations ΔPfl and ΔPfr for each wheel cylinder, and then proceeds to Step S40. The control modes include a pressure-increasing mode, a pressure-reducing mode, and a pressure-holding mode.

At Step S40, control unit CU controls hydraulic pump P on the basis of desired front left and right wheel cylinder pressures P*fl and P*fr, and deviations ΔPfl and ΔPfr, and then proceeds to Step S50.

At Step S50, control unit CU determines whether or not to employ a continuously-varying mode for front left and right inlet valves IN/V(FL) and IN/V(FR). When the answer to Step S50 is affirmative (YES), then control unit CU proceeds to Step S51. On the other hand, when the answer to Step S50 is negative (NO), then control unit CU proceeds to Step S52.

At Step S51, control unit CU controls a respective one of front left and right inlet valves IN/V(FL) and IN/V(FR) by continuously varying its opening, and then proceeds to Step S60.

At Step S52, control unit CU controls the respective one of front left and right inlet valves IN/V(FL) and IN/V(FR) by fully-opening or fully-closing its opening, and then proceeds to Step S60.

At Step S60, control unit CU determines whether or not to employ a continuously-varying mode for front left and right outlet valves OUT/V(FL) and OUT/V(FR). When the answer to Step S60 is YES, then control unit CU proceeds to Step S61. On the other hand, when the answer to Step S60 is NO, then control unit CU proceeds to Step S62.

At Step S61, control unit CU controls a respective one of front left and right outlet valves OUT/V(FL) and OUT/V(FR) by continuously varying its opening, and then returns from this control process.

At Step S62, control unit CU controls the respective one of front left and right outlet valves OUT/V(FL) and OUT/V(FR) by fully-opening or fully-closing its opening, and then returns from this control process.

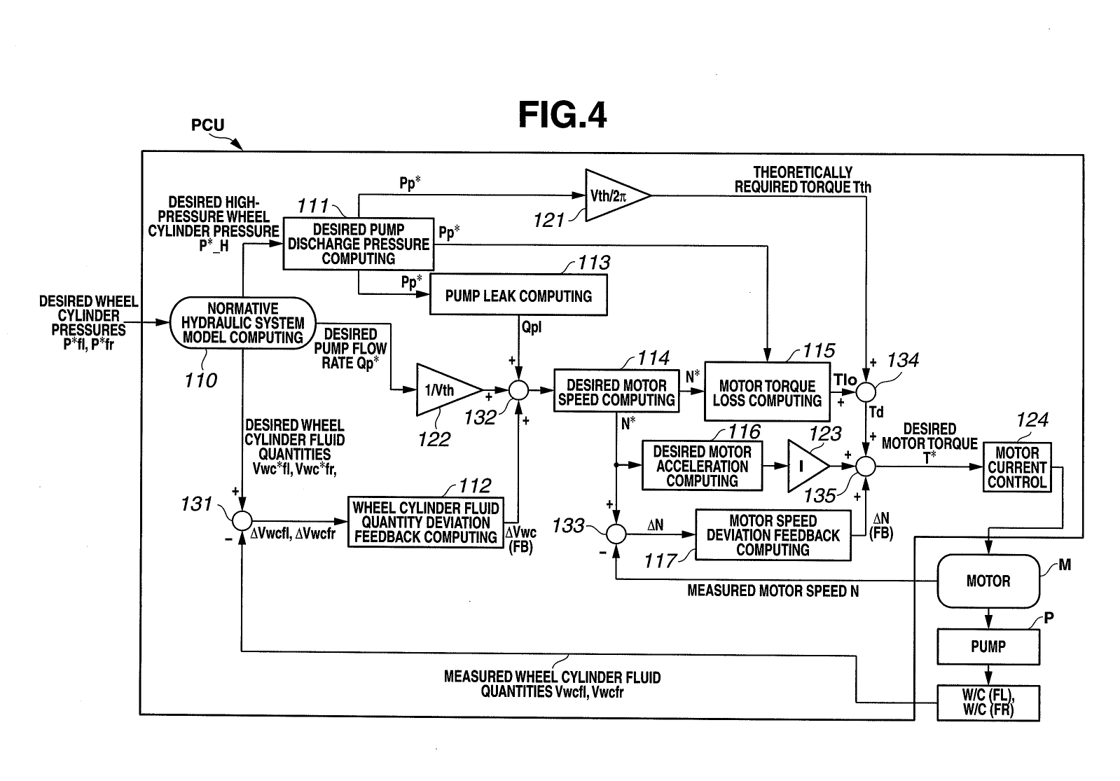

The following describes Step S40 of FIG. 3 in detail with reference to FIG. 4. Control unit CU includes a pump control unit “PCU” for implementing the control process described below.

Pump control unit PCU includes a section referred to as normative hydraulic system model computing section 110, a section referred to as desired pump discharge pressure computing section 111, a section referred to as wheel cylinder fluid quantity deviation feedback computing section 112, a section referred to as pump leak computing section 113, a section referred to as desired motor speed computing section 114, a section referred to as motor torque loss computing section 115, a section referred to as desired motor acceleration computing section 116, and a section referred to as motor speed deviation feedback computing section 117.

Normative hydraulic system model computing section 110 receives a data signal indicative of desired front left and right wheel cylinder pressures P*fl and P*fr, computes a desired pump flow rate “Qp*” of hydraulic pump P on the basis of desired front left and right wheel cylinder pressures P*fl and P*fr, and then outputs a data signal indicative of desired pump flow rate Qp* to a is multiplier 122. Multiplier 122 multiplies desired pump flow rate Qp* by the reciprocal of a theoretical pump discharge fluid quantity “Vth” defined as a theoretically discharge quantity of hydraulic pump P per one rotation. Normative hydraulic system model computing section 110 further computes desired front left and right wheel cylinder fluid quantity “Vwc*fl” and “Vwc*fr” of front left and right wheel cylinders W/C(FL) and W/C(FR) on the basis of desired front left and right wheel cylinder pressures P*fl and P*fr, and then outputs a data signal indicative of desired front left and right wheel cylinder fluid quantity Vwc*fl and Vwc*fr to an adder 131. Moreover, normative hydraulic system model computing section 110 computes a desired high-pressure wheel cylinder pressure “P*_H” on the basis of desired front left and right wheel cylinder pressures P*fl and P*fr, and then outputs a data signal indicative of desired high-pressure wheel cylinder pressure P*_H to desired pump discharge pressure computing section 111. For example, when front left inlet valve IN/V(FL) is fully opened so that desired front left wheel cylinder pressure P*fl is higher than desired front right wheel cylinder pressure P*fr, then desired high-pressure wheel cylinder pressure “P*_H” is desired front left wheel cylinder pressure P*fl.

Desired pump discharge pressure computing section 111 computes a desired pump discharge pressure “Pp*” of hydraulic pump P on the basis of desired high-pressure wheel cylinder pressure P*_H, and then outputs a data signal indicative of desired pump discharge pressure Pp* to pump leak computing section 113, motor torque loss computing section 115, and a multiplier 121.

Multiplier 121 computes a theoretically required torque “Tth” of hydraulic pump P by multiplying the desired pump discharge pressure Pp* by a factor of Vth/2n, and then outputs a data signal indicative of theoretically required torque Tth to an adder 134.

Adder 131 computes deviations “ΔVwcfl” and “ΔVwcfr” by subtracting measured wheel cylinder fluid quantities “Vwcfl” and “Vwcfr” of front left and right wheel cylinders W/C(FL) and W/C(FR) from desired front left and right wheel cylinder fluid quantity Vwc*fl and Vwc*fr. Wheel cylinder fluid quantity deviation feedback computing section 112 computes a feedback component “ΔVwc(FB)” on the basis of deviations ΔVwcfl and ΔVwcfr, and then outputs a data signal indicative of feedback component ΔVwc(FB) to an adder 132.

Pump leak computing section 113 computes a pump leak quantity “Qpl” of hydraulic pump P on the basis of desired pump discharge pressure Pp* with reference to experimental data, and then outputs a data signal indicative of pump leak quantity Qpl to adder 132.

Adder 132 adds pump leak quantity Qpl, feedback component ΔVwc(FB), and the product of desired pump flow rate Qp*, and then outputs a data signal indicative of the sum to desired motor speed computing section 114.

Desired motor speed computing section 114 computes desired motor speed “N*” of electric motor M on the basis of the sum computed at adder 132, and then outputs a data signal indicative of desired motor speed N* to motor torque loss computing section 115, desired motor acceleration computing section 116, and an adder 133.

Motor torque loss computing section 115 computes a torque loss “Tlo” of electric motor M on the basis of desired motor speed N* and desired pump discharge pressure Pp* with reference to experimental data, and outputs a data signal indicative of torque loss Tlo to adder 134.

Desired motor acceleration computing section 116 computes a desired motor acceleration of electric motor M by differentiating the desired motor speed N*, and then outputs a data signal indicative of the desired motor acceleration to an inertia torque computing section 123.

Inertia torque computing section 123 computes an inertia torque of electric motor M to be cancelled for desired motor speed change by multiplying the desired motor acceleration by a moment of inertia, and then outputs a data signal indicative of the inertia torque to an adder 135.

Adder 133 computes a deviation “ΔN” by subtracting the actual motor speed N from desired motor speed N*. Motor speed deviation feedback computing section 117 computes a feedback component “ΔN(FB)” on the basis of deviation ΔN, and then outputs a data signal indicative of feedback component ΔN(FB) to adder 135.

Adder 134 computes a load torque “Td” of electric motor M by adding theoretically required torque Tth of electric motor M and torque loss Tlo of electric motor M, and then outputs a data signal indicative of load torque Td to adder 135.

Adder 135 computes a desired motor output torque “T*” of electric motor M by adding the load torque Td of electric motor M, feedback component ΔN(FB), and the inertia torque to be cancelled, and then outputs a data signal indicative of desired motor output torque T* to a motor current control section 124.

Motor current control section 124 computes a desired motor drive current on the basis of desired motor output torque T*, and then outputs the desired motor drive current to electric motor M, so that electric motor M drives hydraulic pump P.

Pump control unit PCU of control unit CU thus controls motor speed N, pump discharge pressure Pp, and front left and right wheel cylinder pressures Pfl and Pfr on the basis of feedback of actual motor speed N and actual wheel cylinder fluid quantities Vwcfl and Vwcfl, so that motor speed N, pump discharge pressure Pp, and front left and right wheel cylinder pressures Pfl and Pfr may follow desired motor speed N*, desired pump discharge pressure Pp*, and desired front left and right wheel cylinder pressures P*fl and P*fr, respectively.

If pump control unit PCU was configured to stop supplying the motor drive current in response to a request for quickly stopping the hydraulic pump P, then hydraulic pump P would continue to rotate due to the inertia of hydraulic pump P, electric motor M and the operating fluid, after the request for quickly stopping the hydraulic pump P. As a result, actual motor speed N would deviate from desired motor speed N*. On the other hand, according to the foregoing control process in the first embodiment, in response to such a request for quickly stopping the hydraulic pump P, pump control unit PCU produces a motor torque current “Iq” applied to electric motor M in the reverse direction so as to apply a reverse torque to hydraulic pump P. This is effective for quickly stopping the hydraulic pump P. In summary, control unit CU is configured to produce a torque applied to electric motor M in a first rotational direction, while carrying out a transition from a first operating state to a second operating state, the first operating state being an operating state that electric motor M is rotating in a second rotational direction opposite to the first rotational direction so as to allow the hydraulic pump P to pressurize the brake fluid in front left and right wheel cylinders W/C(FL) and W/C(FR), the second operating state being an operating state that a discharge pressure of hydraulic pump P is lower than in the first operating state or an operating state that the pump is stopped from pressurizing the brake fluid in the wheel cylinder.

The following describes a control process to be performed by motor current control section 124 of pump control unit PCU of control unit CU. Electric motor M in this example is a three-phase direct current (DC) brushless motor. Motor current control section 124 implements a motor vector control as follows.

As described above, during control of the baking efforts generated by hydraulic unit HU, motor current control section 124 controls the electric motor M in accordance with desired motor output torque T*. In order to obtain desired motor output torque T*, motor current control section 124 controls three-phase motor drive currents applied to the three-phase DC brushless motor M, in accordance with rotation of the magnetic field.

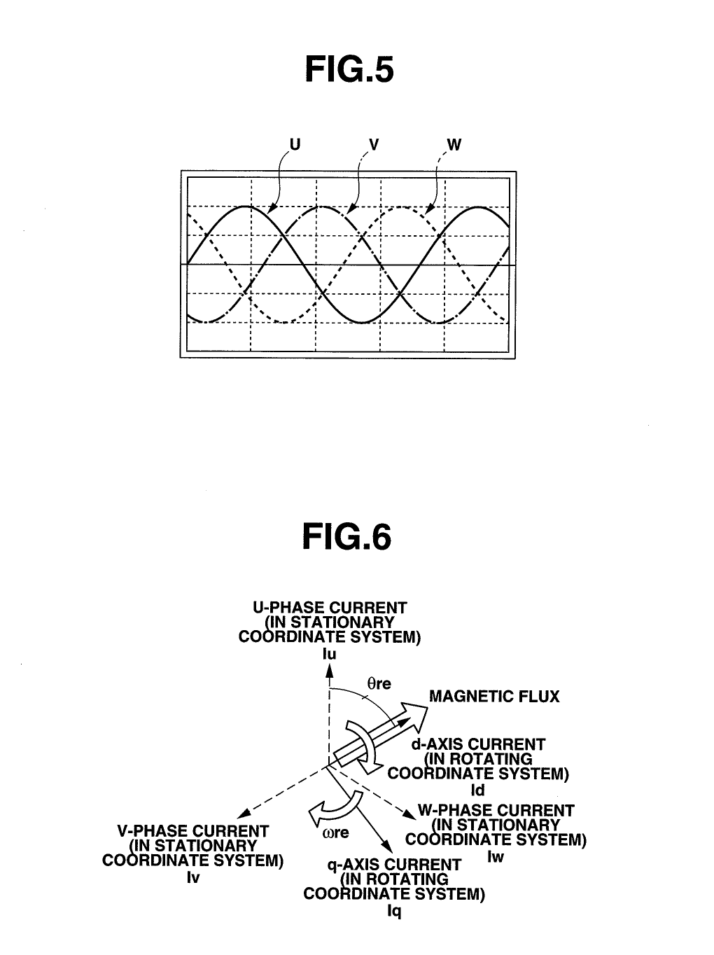

FIG. 5 shows a general example of waveforms of three-phase drive currents applied to three-phase DC brushless motors, in which the three-phase drive currents are three-phase alternating currents. In general, it is relatively difficult to control the output torque of such a three-phase DC brushless motor on the basis of the three-phase alternating current (AC) stationary coordinate system (u, v, w). In order to simply construct the control system, so-called a motor vector control is employed. In the motor vector control, a coordinate transformation from the three-phase AC stationary coordinate system (u, v, w) to an equivalent two-axis DC rotating coordinate system is made to transform the three-phase AC motor drive currents (Iu, Iv, Iw) to equivalent two-axis DC motor drive currents, as shown in FIG. 6. The equivalent two-axis DC motor drive currents include a motor torque current (quadrature axis current) Iq and a motor magnetizing current (direct axis current) Id. Motor output torque T is proportional to motor torque current Iq. The motor vector control for controlling the output torque of electric motor M is implemented by creating a control system for controlling two-axis DC motor drive currents of a DC motor equivalent to electric motor M, and then transforming the control system so as to supply three-phase AC motor drive currents to electric motor M.

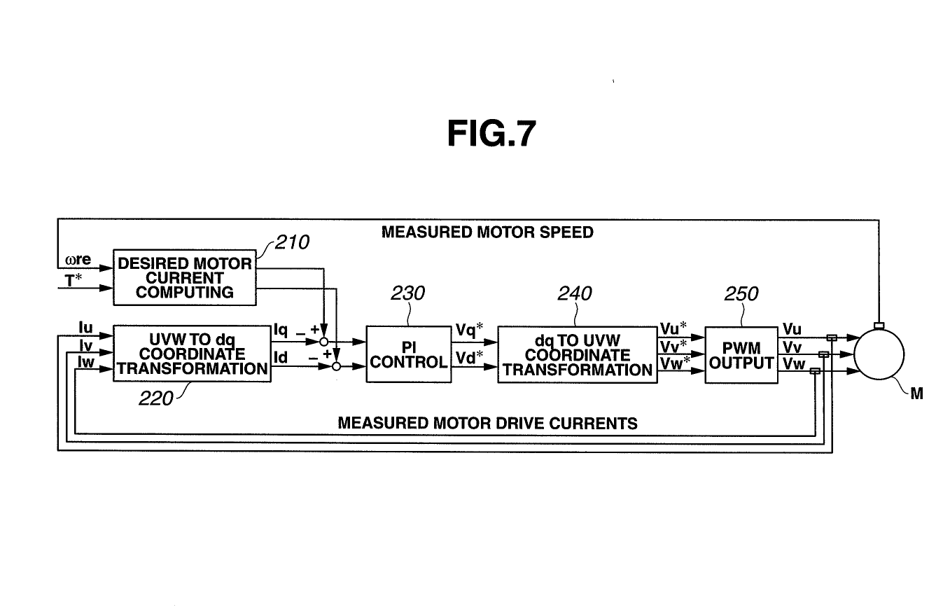

The following describes a detailed configuration of motor current control section 124 for implementing the motor vector control with reference to FIG. 7. Motor current control section 124 includes a part referred to as desired motor current computing part 210, a part referred to as UVW to dq coordinate transformation part 220, a part referred to as PI control part 230, a part referred to as dq to UVW coordinate transformation part 240, and a part referred to as PWM output part 250.

Desired motor current computing part 210 computes a desired motor torque current Iq* and a desired motor magnetizing current Id* on the basis of desired motor output torque T* of electric motor M.

The UVW to dq coordinate transformation part 220 computes actual motor torque current Iq and actual motor magnetizing current Id on the basis of data signals from a current sensor and a magnetic pole position sensor.

The PI control part 230 computes a desired motor torque voltage Vq* and a desired motor magnetizing voltage Vd* on the basis of desired motor torque current Iq*, desired motor magnetizing current Id* and their deviations from actual motor torque current Iq and actual motor magnetizing current Id.

The dq to UVW coordinate transformation part 240 performs a coordinate transformation to transform desired motor torque voltage Vq* and desired motor magnetizing voltage Vd* to desired three phase alternating motor drive voltages Vu*, Vv* and Vw*.

PWM output part 250 computes three-phase PWM (pulse width modulation) duty ratios on the basis of desired three phase alternating motor drive voltages Vu*, Vv* and VW*, and accordingly outputs drive signals to FETs (Field Effect Transistors) so as to drive the electric motor M.

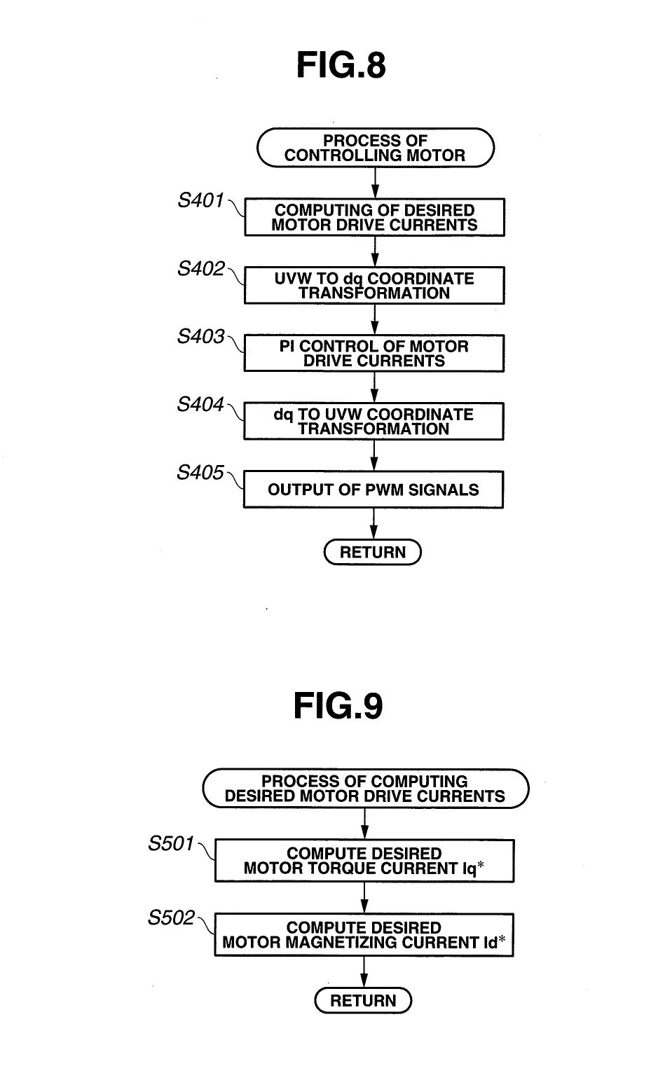

The following describes a main control process of motor vector control to be performed by motor current control section 124 of pump control unit PCU of control unit CU with reference to FIG. 8.

At Step S401, motor current control section 124 computes desired motor torque current Iq* and desired motor magnetizing current Id*, and then proceeds to Step S402.

At Step S402, motor current control section 124 performs a UVW to dq coordinate transformation, and then proceeds to Step S403.

At Step S403, motor current control section 124 performs a PI control of motor drive currents, and then proceeds to Step S404.

At Step S404, motor current control section 124 performs a dq to UVW coordinate transformation, and then proceeds to Step S405.

At Step S405, motor current control section 124 outputs PWM signals, and returns from this control process.

The following describes in detail the function of desired motor current computing part 210 of motor current control section 124 or Step S401 with reference to FIG. 9.

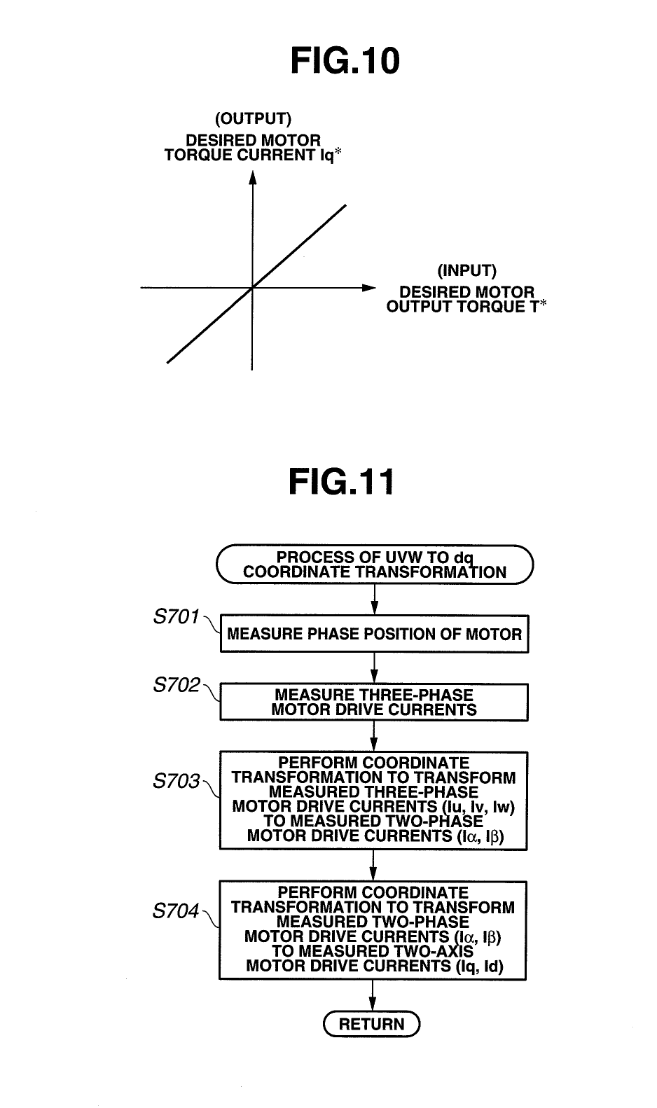

At Step S501, desired motor current computing part 210 computes desired motor torque current Iq* on the basis of desired motor output torque T*, and then proceeds to Step S502. The computing of desired motor torque current Iq* is implemented according to a predetermined map as shown in FIG. 10. Specifically, desired motor torque current Iq* is calculated in proportion to desired motor output torque T* using the following equation.

Iq*=T*×Gq

where Gq represents a constant coefficient.

When desired motor torque current Iq* is equal to a positive value, then electric motor M generates a clockwise torque (in a normal direction to raise pump discharge pressure Pp). On the other hand, when desired motor torque current Iq* is equal to a negative value, then electric motor M generates a counterclockwise torque (in a reverse direction to reduce pump discharge pressure Pp). If hydraulic pump P is arranged such that the sign of motor output torque T is different from the sign of motor torque current Iq, the constant coefficient Gq may be set at a negative value.

At Step S502, desired motor current computing part 210 computes desired motor magnetizing current Id*, and then returns from this control process.

The following describes in detail the function of UVW to dq coordinate transformation part 220 of motor current control section 124 or Step S402 with reference to FIG. 11.

At Step S701, UVW to dq coordinate transformation part 220 identifies the phase position of electric motor M on the basis of data signals from the magnetic pole position sensor, and then proceeds to Step S702. Specifically, control unit CU computes an electrical angle Ore defined as an angle in the clockwise direction with respect to the U phase. In this example, the magnetic pole position sensor is arranged to output a signal indicative of electrical angle Ore.

At Step S702, UVW to dq coordinate transformation part 220 measures actual three phase alternating motor drive currents Iu, Iv and Iw, and then proceeds to Step S703.

At Step S703, UVW to dq coordinate transformation part 220 performs a coordinate transformation to transform three phase alternating motor drive currents Iu, Iv and Iw to equivalent two-phase alternating currents Iα and Iβ, and then proceeds to Step S704.

At Step S704, UVW to dq coordinate transformation part 220 performs a coordinate transformation to transform two-phase alternating currents Iα and Iβ to equivalent two-axis DC motor drive currents Iq and Id, and then returns from this control process.

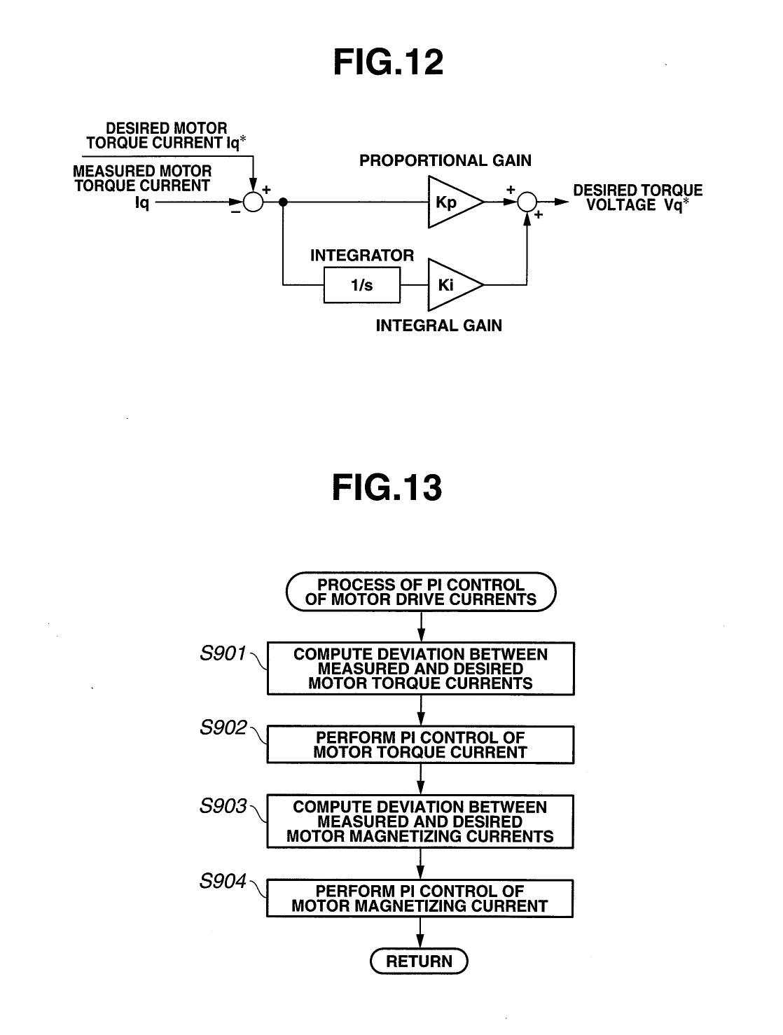

The following describes in detail the function of PI control part 230 of motor current control section 124 or Step S403 with reference to FIGS. 12 and 13. As shown in FIG. 12, PI control part 230 performs a PI (Proportional-Integral) control, computing desired motor torque voltage Vq* on the basis of desired motor torque current Iq*, measured motor torque current Iq, a proportional gain Kp, and an integral gain Ki. Similarly, PI control part 230 performs a PI control, computing desired motor magnetizing voltage Vd* on the basis of desired motor magnetizing current Id* and measured motor magnetizing current Id.

PI control part 230 performs a control process as shown in FIG. 13. At Step S901, PI control part 230 computes a deviation between desired motor torque current Iq* and measured motor torque current Iq, and then proceeds to Step S902.

At Step S902, PI control part 230 performs a PI control of motor torque current Iq, and then proceeds to Step S903.

At Step S903, PI control part 230 computes a deviation between desired motor magnetizing current Id* and measured motor magnetizing current Id, and then proceeds to Step S904.

At Step S904, PI control part 230 performs a PI control of motor magnetizing current Id, and then returns from this control process.

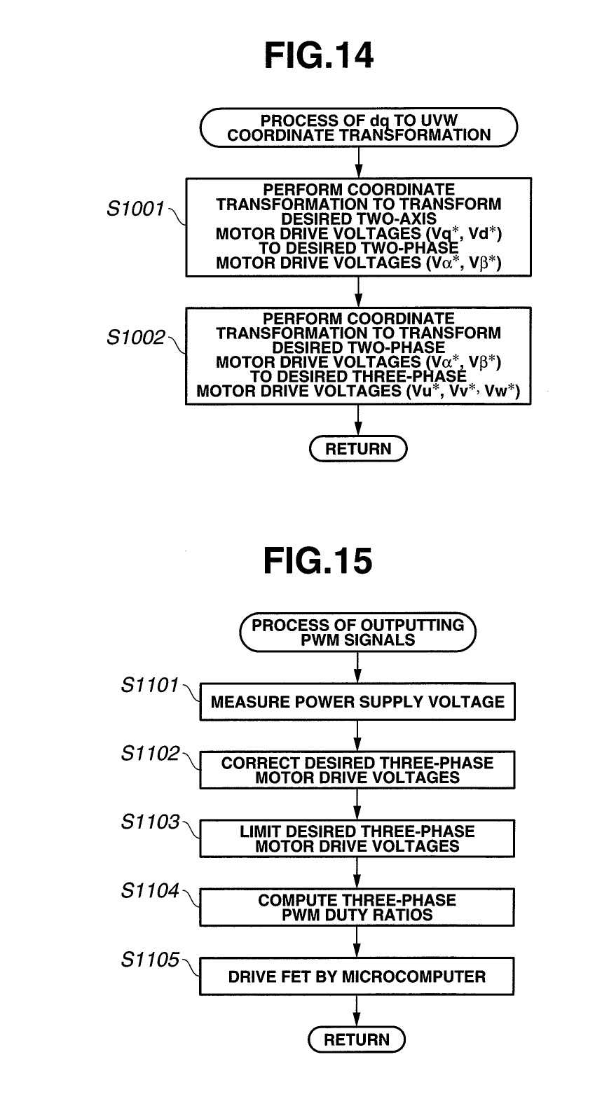

The following describes in detail the function of dq to UVW coordinate transformation part 240 of motor current control section 124 or Step S404 with reference to FIG. 14.

At Step S1001, dq to UVW coordinate transformation part 240 performs a coordinate transformation to transform the desired motor torque voltage Vq* and desired motor magnetizing voltage Vd* to equivalent desired two-phase alternating motor drive voltages Vα and Vβ, and then proceeds to Step S1002.

At Step S1002, dq to UVW coordinate transformation part 240 performs a coordinate transformation to transform desired two-phase alternating motor drive voltages Vα* and Vβ* to equivalent desired is three-phase alternating motor drive voltages Vu*, Vv* and Vw*, and then returns from this control process.

The following describes in detail the function of PWM output part 250 of motor current control section 124 or Step S405 with reference to FIG. 15.

At Step S1101, PWM output part 250 receives a data signal from a power supply voltage sensor, and identifies a reference voltage Eb which is used to set PWM signals, and then proceeds to Step S1102.

At Step S1102, PWM output part 250 corrects the desired three-phase alternating motor drive voltages Vu*, Vv* and Vw*, and then proceeds to Step S1103. Possible voltages V are within a range of 0≦V≦Eb, although the desired three-phase alternating motor drive voltages Vu*, Vv* and Vw* change in a range extending in negative and position directions from zero. Accordingly, the desired three-phase alternating motor drive voltages Vu*, Vv* and Vw* are corrected to shift by an amount of Eb/2 using the following equation.

Vx*buf=Vx*+Eb/2 (x=u, v, w)

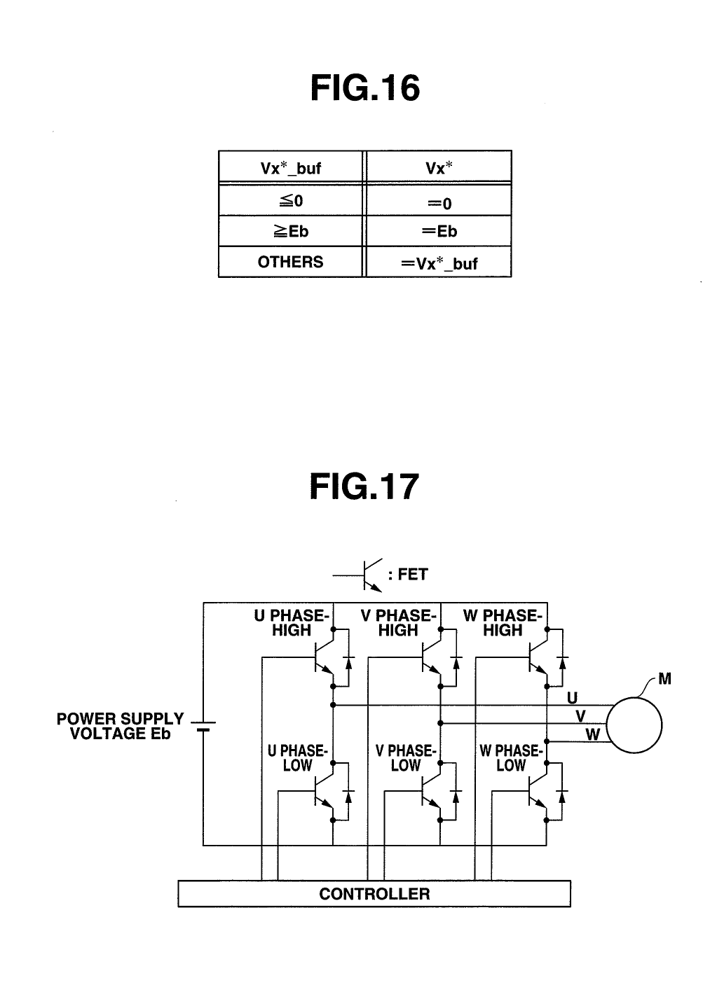

At Step S1103, PWM output part 250 limits the desired three-phase alternating motor drive voltages Vu*buf, Vv*buf and Vw*buf within a predetermined possible range of 0≦V≦Eb, as shown in FIG. 16, and then proceeds to Step S1104.

At Step S1104, PWM output part 250 sets three-phase PWM duty ratios Du, Dv and Dw so as to attain the corrected and limited desired three-phase alternating motor drive voltages Vu*buf, Vv*buf and Vw*buf, and then proceeds to Step S1105. The three-phase PWM duty ratios Du, Dv and Dw are set using the following equation.

Dx=(Vx*buf/Eb)×100 (x=u, v, w)

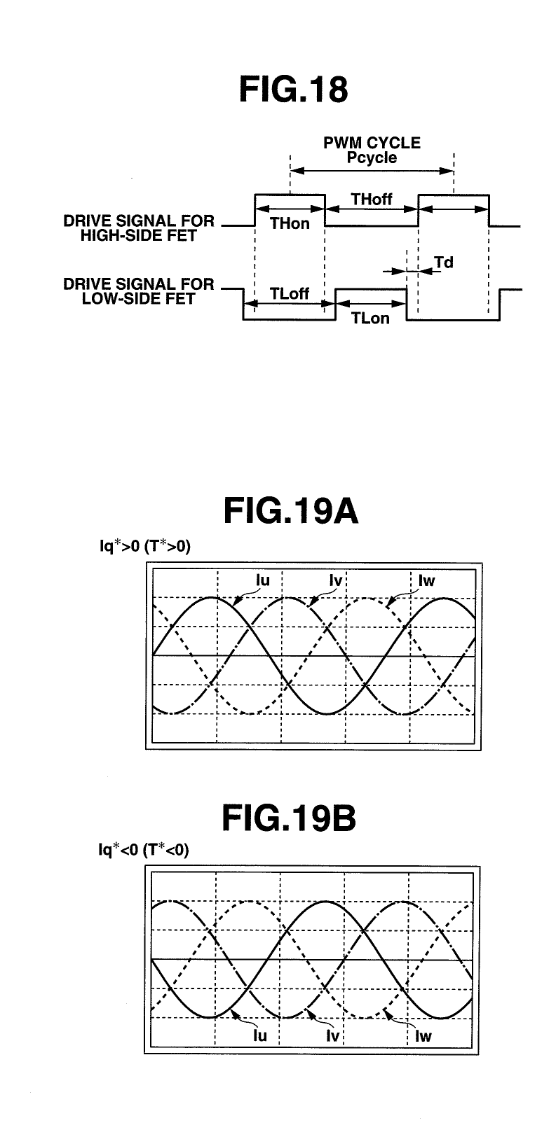

At Step S1105, PWM output part 250 drives the FETs in PWM output part 250 by a microcomputer, so as to drive electric motor M, and then returns from this control process. FIG. 17 shows a detailed configuration of PWM output part 250. FIG. 18 shows a pattern of FET drive signals. In this pattern, Pcycle represents a cycle or period of PWM, THon represents a period in which the high-side FET is in the on-state, THoff represents a period in which the high-side FET is in the off-state, TLon represents a period in which the low-side FET is in the on-state, TLoff represents a period in which the low-side FET is in the off-state, and Td represents a dead time. These parameters are set using the following equations.

THon_{—}x=Pcycle·Dx/100

THoff_{—}x=Pcycle−THon_{—}x

TLon_{—}x=Pcycle−TLoff_{—}x

TLoff_{—}x=THon_{—}x+2Td

(x=u, v, w)

The microcomputer controls the level of output ports connected to respective gates of the FETs in accordance with the thus computed timings, i.e. THon_x, THoff_x, TLon_x and TLoff_x.

The following describes a relationship between desired motor torque current Iq* and three phase alternating motor drive currents Iu, Iv and Iw with reference to FIGS. 19A and 19B. Three phase alternating motor drive currents Iu, Iv and Iw are generated by repeatedly turning on the output port level of the FETs of PWM output part 250 for passing currents, or turning off the same. Since three phase alternating motor drive currents Iu, Iv and Iw are controlled to change in accordance with desired motor torque current Iq*, motor output torque T follows desired motor output torque T*. If it is desired to change the sign of desired motor output torque T*, it is implemented by changing the sign of desired motor torque current Iq*. Control unit CU applies a positive torque current to electric motor M while producing a torque applied to electric motor M in the normal rotational direction, and to apply a negative torque current to electric motor M while producing a torque applied to electric motor M in the reverse rotational direction.

The control process of motor current control is repeatedly performed ten times or more within a period of alternating currents when electric motor M is operated at a maximum allowable rotational speed, in order to enhance the response of motor torque current Iq to desired motor torque current Iq*. The period of the control process of motor current control is set shorter than that of the control process of computing of desired motor output torque T*. This is effective for simply and accurately controlling the output torque of electric motor M with a low computing load, and accordingly, improving the response of braking operation during rapid braking, and reducing noises due to the braking operation.

According to the foregoing control process based on motor vector control, when it is desired to stop hydraulic pump P or electric motor M under condition that front left and right wheel cylinders W/C(FL) and W/C(FR) are being pressurized by hydraulic pump P or electric motor M, then control unit CU produces a torque applied to electric motor M in a direction opposite to the direction to pressurize front left and right wheel cylinders W/C(FL) and W/C(FR). This is effective for preventing the hydraulic pump P from continuing to rotate due to the inertia of electric motor M, hydraulic pump P, and the operating fluid after a request for stopping the hydraulic pump P, preventing the pump discharge pressure Pp from overshooting the desired pump discharge pressure Pp*, and thus enhancing the accuracy of the control of wheel cylinder pressures at the time of stop of hydraulic pump P.

Also, when it is desired to reduce the rate of change of front left and right wheel cylinder pressures Pfl and Pfr, then control unit CU may produce a torque applied to electric motor M in a direction opposite to the pressurizing direction of hydraulic pump P. In other words, control unit CU is configured to produce a torque applied to electric motor M in a first rotational direction, while carrying out a transition from a first operating state to a second operating state, the first operating state being an operating state that electric motor M is rotating in a second rotational direction opposite to the first rotational direction so as to allow hydraulic pump P to increase the internal pressure of front left and right wheel cylinders W/C(FL) and W/C(FR) at a first rate of change with respect to time, the second operating state being an operating state that electric motor M is rotating in the second rotational direction so as to allow hydraulic pump P to increase the internal pressure of front left and right wheel cylinders W/C(FL) and W/C(FR) at a second rate of change with respect to time, the second rate being lower than the first rate.

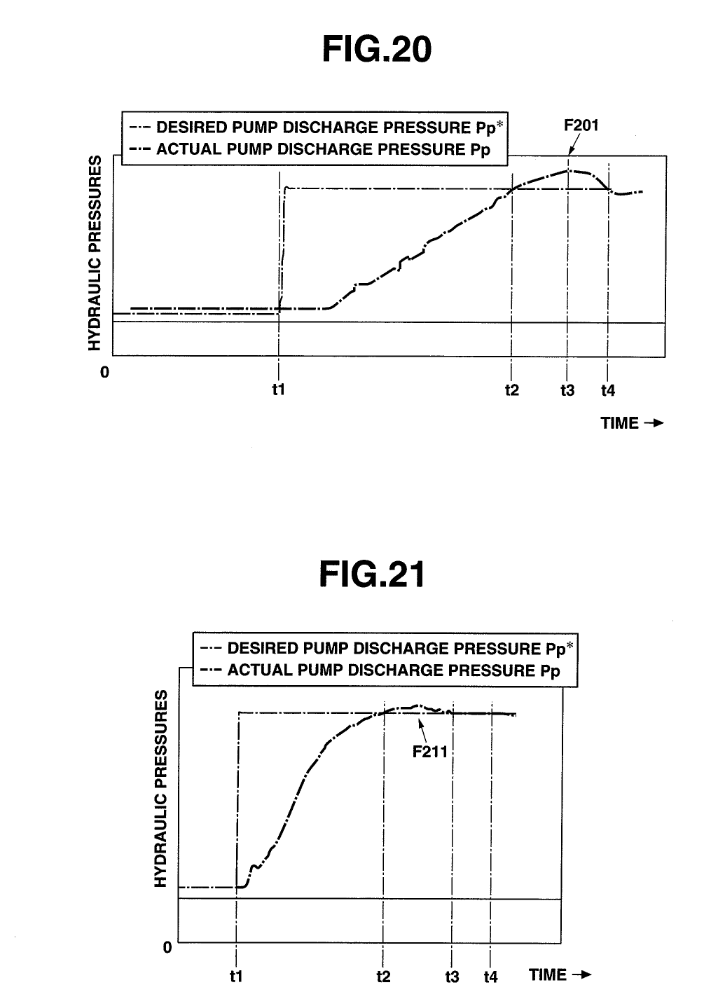

The following describes a comparison between the first embodiment and a comparative example with reference to FIGS. 20 to 27. FIG. 20 shows an example of how pump discharge pressure Pp changes with time under control for pressure increase in the comparative example, and FIG. 21 shows an example of how pump discharge pressure Pp changes with time under control for pressure increase in the first embodiment. Control unit CU sets desired front left and right wheel cylinder pressures P*fl and P*fr, and desired pump discharge pressure Pp* in such a manner that desired front left and right wheel cylinder pressures P*fl and P*fr, and desired pump discharge pressure Pp* change stepwise with respect to time. Time instants t1 to t4 in FIG. 20 are identical to those in FIG. 21.

At time t1, control unit CU issues such a control command that desired pump discharge pressure Pp* rapidly rises stepwise at time t1, and is held constant after time t1. In both of the comparative example shown in FIG. 20 and the first embodiment shown in FIG. 21, after time t1, pump discharge pressure Pp is controlled to increase in response to the rise of desired pump discharge pressure Pp*.

At time t2, in both of the comparative example shown in FIG. 20 and the first embodiment shown in FIG. 21, pump discharge pressure Pp reaches desired pump discharge pressure Pp*. After time t2, pump discharge pressure Pp exceeds or overshoots desired pump discharge pressure Pp*, because actual motor speed N starts to decrease with a delay after time t2 to due the inertia of hydraulic pump P, electric motor M and the operating fluid. The amount of overshoot in the first embodiment shown in FIG. 21 is smaller than that in the comparative example, as indicated by F201 and F211 in FIGS. 20 and 21, because control unit CU controls electric motor M to produce and apply a reverse torque to hydraulic pump P in accordance with the pump control process of Step S40 in the first embodiment.

At time t3, in the first embodiment shown in FIG. 21 in which the reverse torque is applied, the pump discharge pressure Pp decreases to be equal to desired pump discharge pressure Pp*. On the other hand, in the comparative example shown in FIG. 20, the pump discharge pressure Pp is still above the desired pump discharge pressure Pp*, because actual motor speed N is not reduced yet.

At time t4, in the comparative example shown in FIG. 20, the pump discharge pressure Pp decreases to be equal to desired pump discharge pressure Pp*.

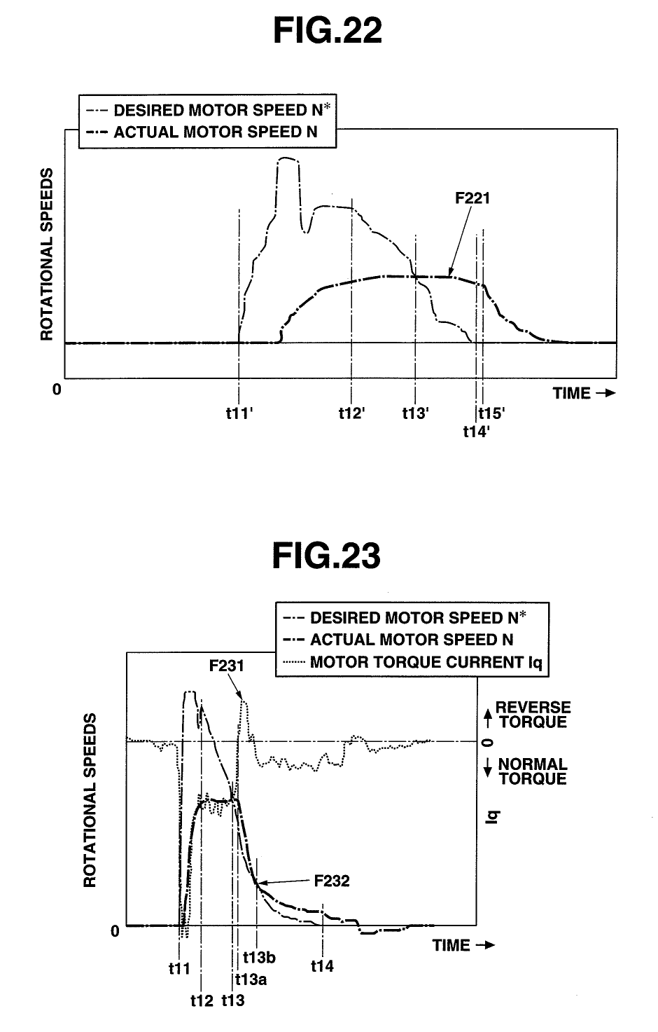

FIG. 22 shows an example of how actual motor speed N changes with time in the comparative example.

At time t11′, control unit CU issues such a control command that desired motor speed N* starts to rise quickly. In response to the rise of desired motor speed N*, actual motor speed N starts to rise with a delay after time t11′.

At time t12′, desired motor speed N* is set to start to decrease. However, actual motor speed N continues to rise, because no suitable reverse torque is generated by electric motor M in the comparative example.

At time t13′, actual motor speed N reaches desired motor speed N*. Although desired motor speed N* continues to decrease, actual motor speed N is not reduced yet. This is because the rotational speed of hydraulic pump P is maintained due to the inertia of electric motor M, hydraulic pump P and the operating fluid. Thus, actual motor speed N deviates from desired motor speed N* after time t13′, as indicated by F221 in FIG. 22.

At time t14′, desired motor speed N* is set at zero. On the other hand, actual motor speed N is high above zero, although slightly decreasing. The deviation between actual motor speed N and desired motor speed N* is still large.

At time t15′, actual motor speed N starts to rapidly decrease and approaches zero. Thus, in the comparative example, after desired motor speed N* becomes zero, the deviation between actual motor speed N and desired motor speed N* starts to decrease.

FIG. 23 shows an example of how actual motor speed N changes with time in the first embodiment.

At time t11, desired motor speed N* is set to start to increase stepwise. In response to this, actual motor speed N starts to rise with a delay.

At time t12, desired motor speed N* is set to start to decrease gradually.

At time t13, actual motor speed N is equal to desired motor speed N* that continues to decrease.

At time t13a, motor torque current Iq enters a region for generating a reverse torque, as indicated by F231 in FIG. 23. Accordingly, actual motor speed N starts to decrease quickly, following the desired motor speed N*.

The deviation between actual motor speed N and desired motor speed N* starts to decrease.

At time t13b, actual motor speed N becomes substantially equal to desired motor speed N*, as indicated by F232 in FIG. 23.

At time t14, desired motor speed N* is set at zero. The actual motor speed N is still above zero, but is lower and closer to desired motor speed N* than in the comparative example.

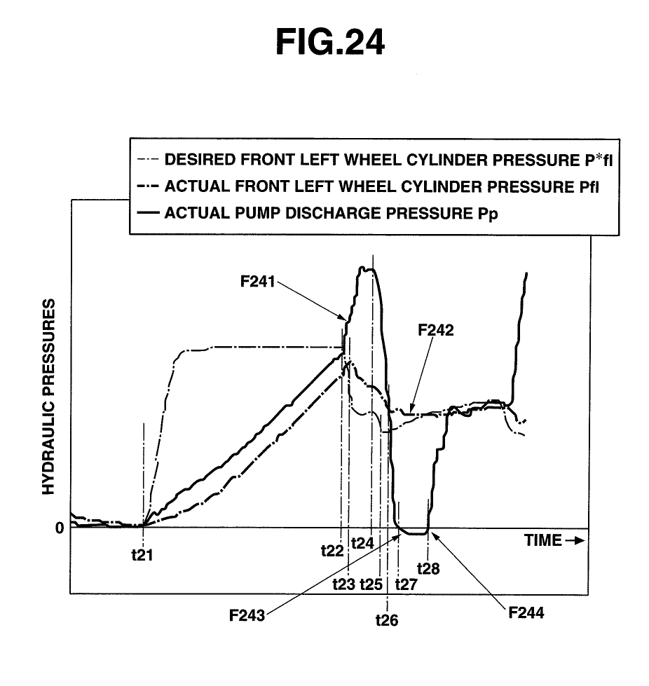

The following describes an example of how front left wheel cylinder pressure Pfl changes with time under control of ABS in the comparative example with reference to FIG. 24.

At time t21, desired front left wheel cylinder pressure P*fl is set to start to rise stepwise. In response to this, pump discharge pressure Pp and front left wheel cylinder pressure Pfl start to increase gradually.

At time t22, desired front left wheel cylinder pressure P*fl is set to start to decrease, and at the same time, pump discharge pressure Pp exceeds desired front left wheel cylinder pressure P*fl. Although it is unnecessary to further increase pump discharge pressure Pp, pump discharge pressure Pp continues to increase due to the inertia of electric motor M, hydraulic pump P and the operating fluid after time t22, because no suitable reverse torque is applied to electric motor M. The volumetric capacity of fluid passage F disposed on the discharge side of hydraulic pump P is set small for compactness of hydraulic unit HU. Therefore, even when hydraulic pump P discharges a small amount of operating fluid due to the inertia of electric motor M, hydraulic pump P and the operating fluid under condition that front left and right inlet valves IN/V(FL) and IN/V(FR) are closed, then the pressure in fluid passage F increases significantly, as indicated by F241 in FIG. 24.

At time t23, front left wheel cylinder pressure Pfl peaks, and starts to decrease, following the desired front left wheel cylinder pressure P*fl.

At time t24, the high pressure in fluid passage F on the discharge side of hydraulic pump P serves to stop and reverse the rotation of hydraulic pump P. As a result, pump discharge pressure Pp starts to decrease rapidly.

At time t25, desired front left wheel cylinder pressure P*fl is set to start to increase gradually. Front left wheel cylinder pressure Pfl continues to decrease.

At time t26, pump discharge pressure Pp becomes lower than front left wheel cylinder pressure Pfl, and thereafter, further decreases.

At time t27, pump discharge pressure Pp decreases excessively, and becomes a negative value due to the reverse rotation of hydraulic pump P, as indicated by F243 in FIG. 24. Therefore, even when pump discharge pressure Pp is controlled to increase after time t27, it takes much time to increase pump discharge pressure Pp above a desired level. Also, front left wheel cylinder pressure Pfl cannot be increased gradually in accordance with desired front left wheel cylinder pressure P*fl, as indicated by F242 in FIG. 24.

At time t28, pump discharge pressure Pp becomes a positive value, as indicated by F244 in FIG. 24.

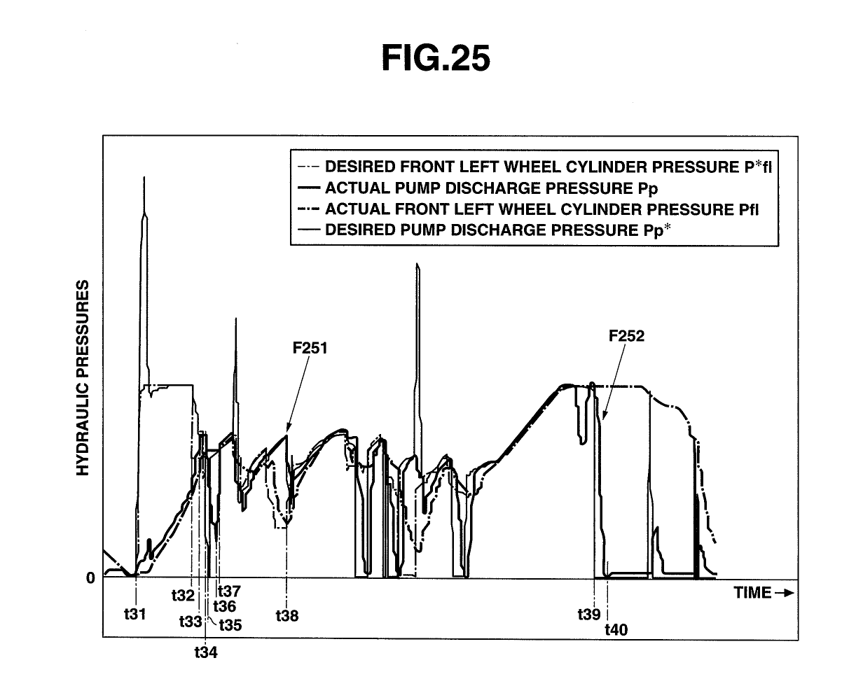

The following describes an example of how front left wheel cylinder pressure Pfl changes with time under control of ABS in the first embodiment with reference to FIG. 25.

At time t31, desired pump discharge pressure Pp* and desired front left wheel cylinder pressure P*fl are set to start to increase stepwise from zero. In response to this, the pump discharge pressure Pp, and front left wheel cylinder pressure Pfl start to increase gradually with delays.

At time t32, desired pump discharge pressure Pp* and desired front left wheel cylinder pressure P*fl are set to start to decrease. At this time, pump discharge pressure Pp and front left wheel cylinder pressure Pfl are increasing.

At time t33, pump discharge pressure Pp exceeds desired pump discharge pressure Pp*, and then stops to increase due to a reverse torque produced and applied to electric motor M.

At time t34, pump discharge pressure Pp quickly decreases in response to a decrease in desired pump discharge pressure Pp*. The amount of overshoot is thus minimized.

At time t35, desired pump discharge pressure Pp* is set at zero, and thereafter, is set to start to increase again.

At time t36, pump discharge pressure Pp shows a local minimum, following the desired pump discharge pressure Pp*. Pump discharge pressure Pp is held above zero, because a suitable torque is applied to electric motor M so as to prevent the hydraulic pump P from rotating excessively in the reverse direction.

At time t37, pump discharge pressure Pp reaches desired pump discharge pressure Pp*, and thereafter, follows desired pump discharge pressure Pp* so that the pressure in fluid passage F disposed on the discharge side of hydraulic pump P is increased gradually. It is thus possible to quickly start to increase pump discharge pressure Pp, because pump discharge pressure Pp is constantly held above zero even when pump discharge pressure Pp is at the local minimum at time t36.

At time t38, desired pump discharge pressure Pp* is set to become a local maximum value. The amount of overshoot of pump discharge pressure Pp with respect to desired pump discharge pressure Pp* is small, because a reverse torque is suitably produced and applied to electric motor M, as indicated by F251 in FIG. 25.

At time t39, pump discharge pressure Pp starts to decrease quickly in response to a rapid decrease in desired pump discharge pressure Pp*. The amount of overshoot of pump discharge pressure Pp is small, as indicated by F252 in FIG. 25.

At time t40, pump discharge pressure Pp becomes a positive local minimum value.

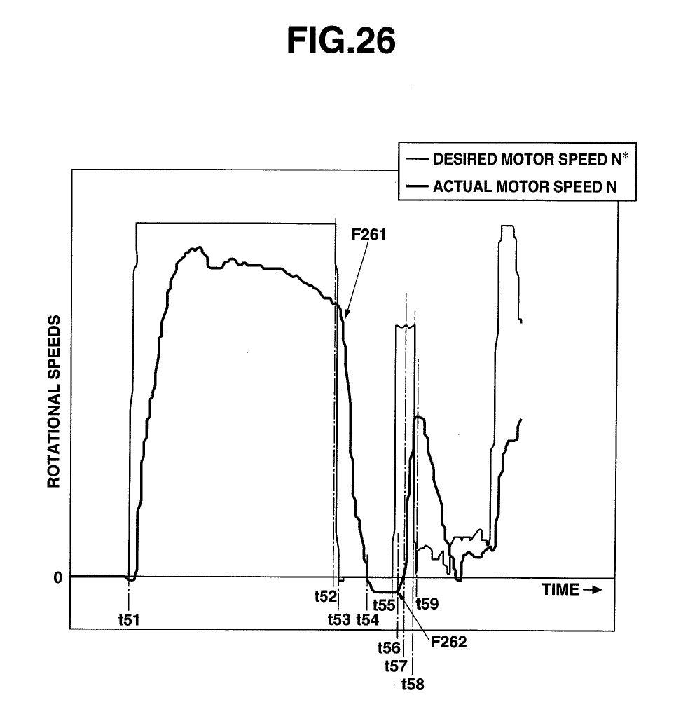

The following describes an example of how actual motor speed N changes with time under control of ABS in the comparative example with reference to FIG. 26. At time t51, desired motor speed N* is set to start increase stepwise from zero.

At time t52, desired motor speed N* is set to start to decrease rapidly.

At time t53, actual motor speed N starts to decrease. However, thereafter, the deviation between actual motor speed N and desired motor speed N* gradually increases, due to the inertia of electric motor M and hydraulic pump P, because no suitable reverse torque is applied to electric motor M, as indicated by F261 in FIG. 26.

At time t54, actual motor speed N becomes zero. Thereafter, actual motor speed N further decreases below zero, because no suitable toque is applied to electric motor M, and the high pressure in fluid passage F on the discharge side of hydraulic pump P causes a reverse rotation of hydraulic pump P, as indicated by F262 in FIG. 26.

At time t55, desired motor speed N* is set to start to increase again. Actual motor speed N is still below zero, so that the deviation between actual motor speed N and desired motor speed N* increases.

At time t56, actual motor speed N starts to increase from a negative local minimum value.

At time t57, actual motor speed N becomes a positive value, and increases with delay. On the other hand, desired motor speed N* is at a local maximum point.

At time t58, desired motor speed N* is set to start to decrease rapidly from the local maximum point.

At time t59, actual motor speed N reaches a local maximum point. At this time, desired motor speed N* is equal to zero. Thus, the delay of actual motor speed N with respect to desired motor speed N* is large.

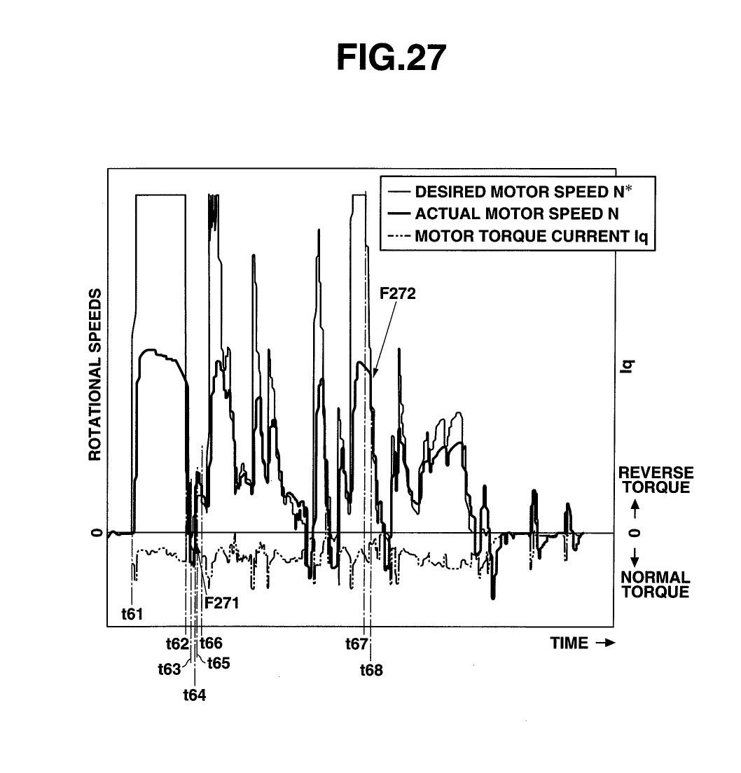

The following describes an example of how actual motor speed N changes with time under control of ABS in the first embodiment with reference to FIG. 27. At time t61, desired motor speed N* is set to start to increase stepwise from zero. In response to this, motor torque current Iq starts to increase in the normal direction.

At time t62, desired motor speed N* starts to decrease rapidly from a local maximum point. In response to this, motor torque current Iq becomes a value for reverse rotation, so as to generate and apply a reverse torque to electric motor M and hydraulic pump P, as indicated by F271 in FIG. 27. As a result, actual motor speed N also starts to decrease quickly with little delay with respect to desired motor speed N*.

At time t63, actual motor speed N becomes zero. Actual motor speed N shows little overshoot, because motor torque current Iq is controlled to apply a suitable torque to electric motor M in a suitable manner. This minimizes the overshoot of pump discharge pressure Pp as at time t33 or t38 in FIG. 25. This prevents hydraulic pump P from reversely rotating for a long period, and actual motor speed N becomes a positive value soon.

At time t64, actual motor speed N becomes a positive value again. At substantially the same time, desired motor speed N* is set to become a local maximum value.

At time t65, actual motor speed N becomes a local maximum value. The desired motor speed N* is still equal to the local maximum value. Thus, the response of actual motor speed N to desired motor speed N* is improved, as compared to the comparative example where, as at time t59 in FIG. 26, actual motor speed N becomes a local maximum value when desired motor speed N* is equal to zero.

At time t66, desired motor speed N* is set to start to decrease rapidly from the local maximum point. At substantially the same time, actual motor speed N starts to decrease rapidly, following the desired motor speed N*.

At time t67, desired motor speed N* is set to start to decrease rapidly from a local maximum point.

At time t68, motor torque current Iq is quickly reduced, so that actual motor speed N follows desired motor speed N*, and so that the deviation between actual motor speed N and desired motor speed N* quickly and gradually decreases, as indicated by F272 in FIG. 27.

The following describes advantageous effects produced by the brake control apparatus according to the first embodiment. As described above, when it is desired to stop hydraulic pump P or electric motor M under condition that front left and right wheel cylinders W/C(FL) and W/C(FR) are pressurized, then control unit CU produces and applies a reverse torque to electric motor M. This is effective for preventing that hydraulic pump P continues to rotate due to the inertia of electric motor M, hydraulic pump P and the operating fluid, and effective for preventing the pump discharge pressure Pp from overshooting the desired pump discharge pressure Pp*, and for improving the accuracy of control of wheel cylinder pressures at the time of stop of hydraulic pump P.

According to the first embodiment, as described above, when it is desired to reduce the rate of change of wheel cylinder pressures, then control unit CU produces and applies a reverse torque to electric motor M. This is effective for preventing that hydraulic pump P continues to rotate due to the inertia of electric motor M, hydraulic pump P and the operating fluid, and effective for preventing the pump discharge pressure Pp from overshooting the desired pump discharge pressure Pp*, and for improving the accuracy of control of wheel cylinder pressures at the time of stop of hydraulic pump P.

According to the first embodiment, the torque applied to electric motor M is controlled so as to control pump discharge pressure Pp and prevent front left and right wheel cylinder pressures Pfl and Pfr from overshooting the desired front left and right wheel cylinder pressures P*fl and P*fr. This control can be implemented more simply and easily, as compared to cases where both of front left and right outlet valves OUT/V(FL) and OUT/V(FR) are controlled so as to prevent front left and right wheel cylinder pressures Pfl and Pfr from overshooting the desired front left and right wheel cylinder pressures P*fl and P*fr.

In the following second to fifth embodiments, the brake control apparatus includes a pressure-regulator for regulating the internal pressures of front left and right wheel cylinders W/C(FL) and W/C(FR), and control unit CU reduces the internal pressures of front left and right wheel cylinders W/C(FL) and W/C(FR) by a pressure-regulator, when electric motor M is rotating in the normal rotational direction so as to allow the pump to pressurize the brake fluid in front left and right wheel cylinders W/C(FL) and W/C(FR).

The following describes a brake control apparatus according to a second embodiment of the present invention. The brake control apparatus according to the second embodiment has a construction and configuration substantially identical to those of the brake control apparatus according to the first embodiment. The second embodiment differs from the first embodiment in that the prevention of overshoot of wheel cylinder pressures is implemented by opening the front left and right outlet valves OUT/V(FL) and OUT/V(FR) in stead of allowing the electric motor M to generate a reverse torque. Reservoir RSV and front left and right outlet valves OUT/V(FL) and OUT/V(FR) serve as a pressure-regulator for regulating the internal pressures of front left and right wheel cylinders W/C(FL) and W/C(FR). Control unit CU implements the reduction of the internal pressures of front left and right wheel cylinders W/C(FL) and W/C(FR) by opening the front left and right outlet valves OUT/V(FL) and OUT/V(FR) so as to allow fluid communication between respective ones of front left and right wheel cylinders W/C(FL) and W/C(FR) and reservoir RSV. The brake control apparatus according to the second embodiment also produces similar advantageous effects as in the first embodiment.

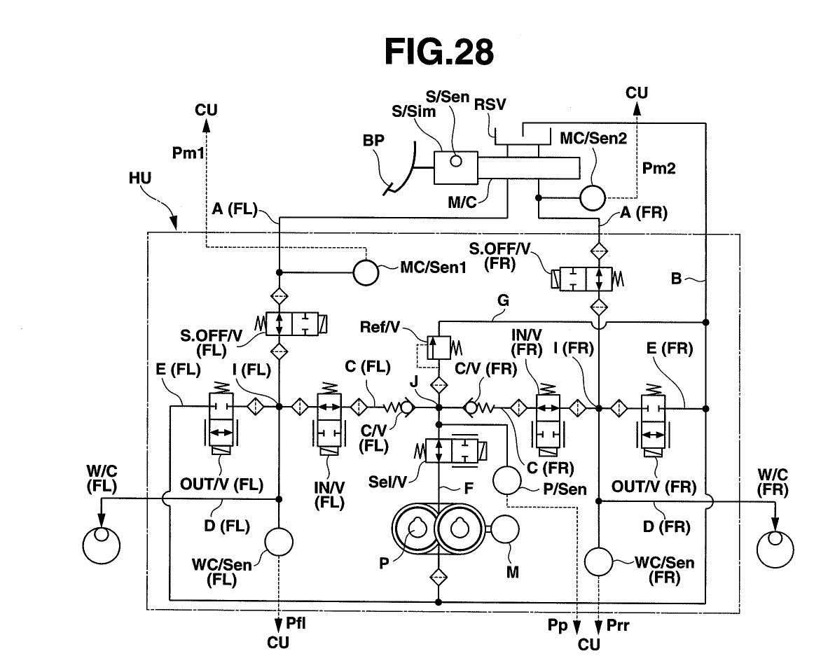

The following describes a brake control apparatus according to a third embodiment of the present invention with reference to FIG. 28. The brake control apparatus according to the third embodiment has a construction and configuration substantially identical to those of the brake control apparatus according to the first embodiment. The third embodiment differs from the first embodiment in that the hydraulic unit HU further includes a selector valve “Sel/V” disposed in fluid passage F on the discharge side of hydraulic pump P, and control unit CU implements the prevention of overshoot of pump discharge pressure Pp by closing the selector valve Sel/V. The selector valve Sel/V is a linear control valve, and serves as a pressure-regulator for regulating the internal pressures of front left and right wheel cylinders W/C(FL) and W/C(FR). Control unit CU implements the reduction of the internal pressures of front left and right wheel cylinders W/C(FL) and W/C(FR) by reducing the opening of selector valve Sel/V so as to restrict fluid communication between hydraulic pump P and respective ones of front left and right inlet valves IN/V(FL) and IN/V(FR). The brake control apparatus according to the third embodiment also produces similar advantageous effects as in the first embodiment.

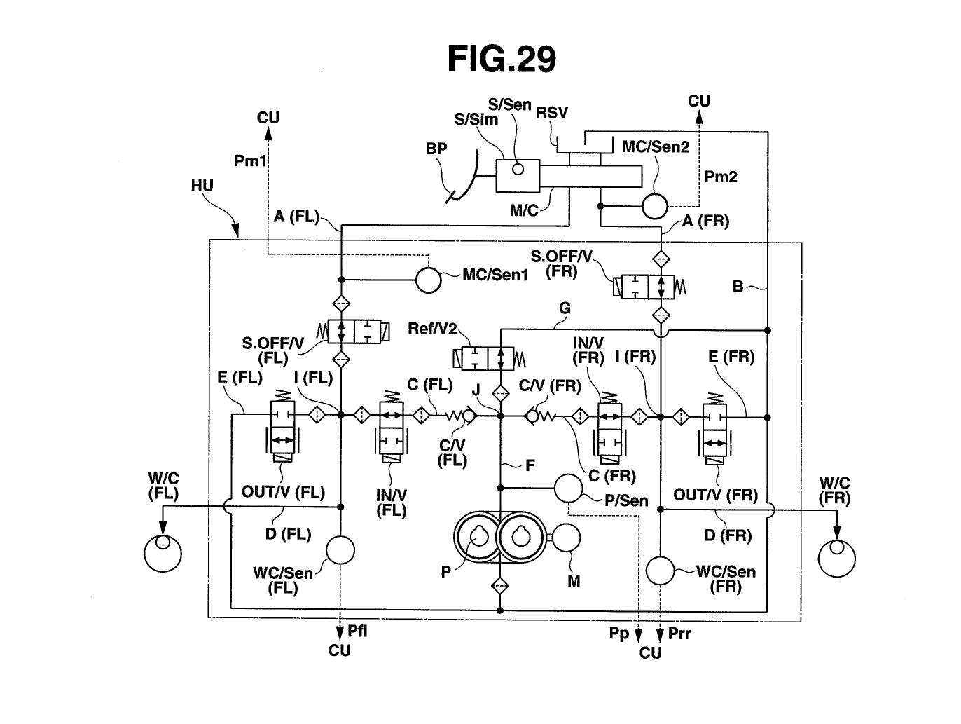

The following describes a brake control apparatus according to a fourth embodiment of the present invention with reference to FIG. 29. The brake control apparatus according to the fourth embodiment has a construction and configuration substantially identical to those of the brake control apparatus according to the first embodiment. The fourth embodiment differs from the first embodiment in that hydraulic unit HU includes an electromagnetic relief valve “Ref/V2” instead of mechanical relief valve Ref/V, and control unit CU implements the prevention of overshoot of pump discharge pressure Pp by opening the relief valve Ref/V2. The relief valve Ref/V2 is a linear control valve disposed in fluid passage G connected between node J and reservoir RSV as a low-pressure section for regulating fluid communication therebetween, and serves as a pressure-regulator for regulating the internal pressures of front left and right wheel cylinders W/C(FL) and W/C(FR). Control unit CU implements the reduction of the internal pressures of front left and right wheel cylinders W/C(FL) and W/C(FR) by opening the relief valve Ref/V2 so as to allow fluid communication between node J and reservoir RSV. The brake control apparatus according to the fourth embodiment also produces similar advantageous effects as in the first embodiment.

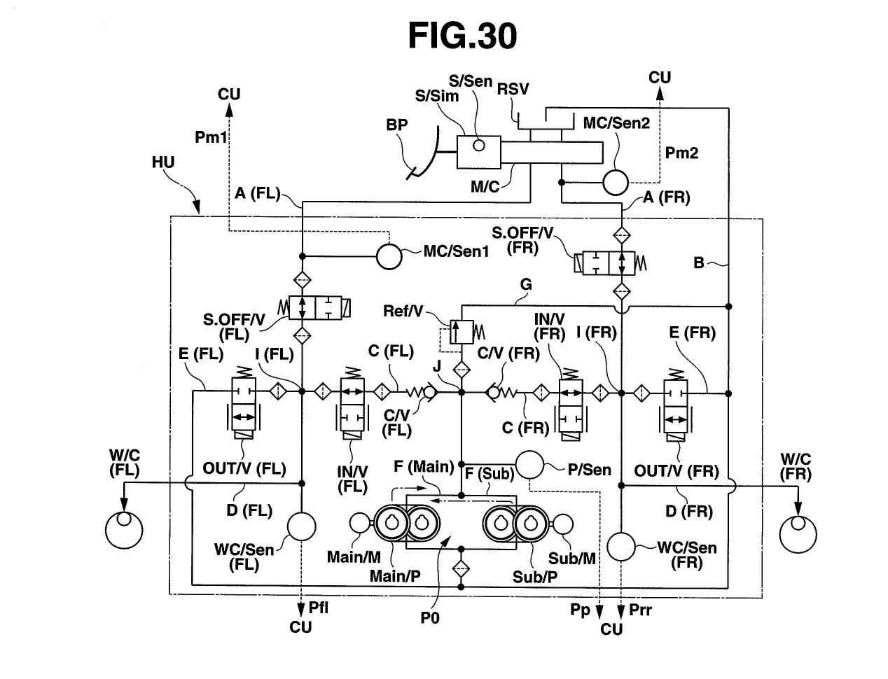

The following describes a brake control apparatus according to a fifth embodiment of the present invention with reference to FIG. 30. The brake control apparatus according to the fifth embodiment has a construction and configuration substantially identical to those of the brake control apparatus according to the first embodiment. The fifth embodiment differs from the first embodiment in that hydraulic unit HU includes a hydraulic pump set “P0” instead of hydraulic pump P, hydraulic pump set P0 includes a main hydraulic pump “Main/P” and a sub hydraulic pump “Sub/P”, and control unit CU implements the prevention of overshoot of pump discharge pressure Pp by allowing the sub hydraulic pump Sub/P to rotate in the reverse direction. The sub hydraulic pump Sub/P serves as a pressure-regulator for regulating the internal pressures of front left and right wheel cylinders W/C(FL) and W/C(FR). Main hydraulic pump Main/P and sub hydraulic pump Sub/P are arranged in parallel, and connected to each other through fluid passages “F(Main)” and “F(Sub)”. The excess rotation of main hydraulic pump Main/P due to the inertia after a request of stop is cancelled by the reverse rotation of sub hydraulic pump Sub/P so as to prevent pump discharge pressure Pp from overshooting the desired pump discharge pressure Pp*.

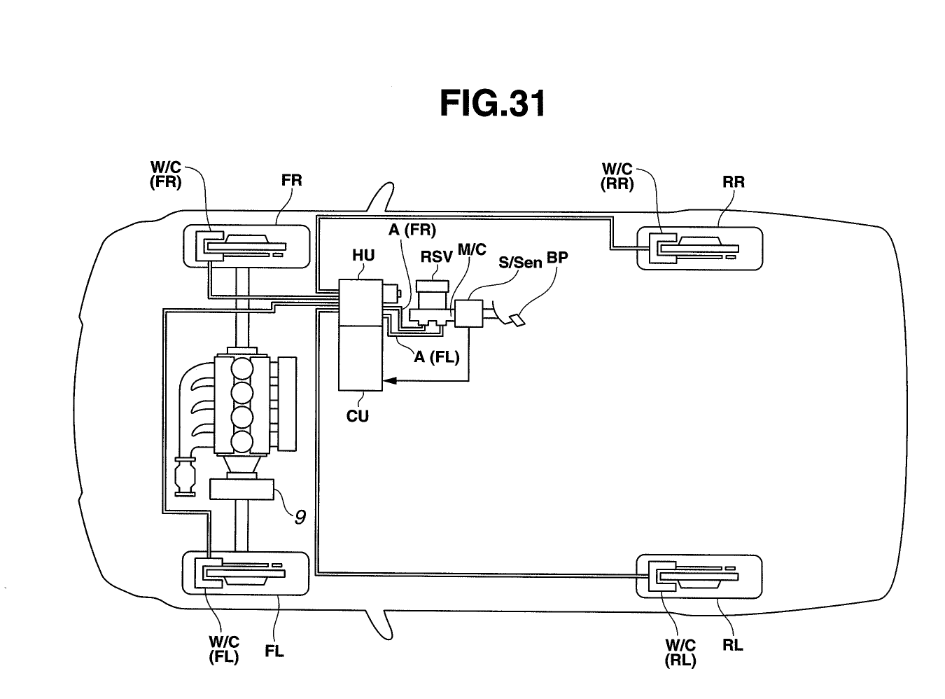

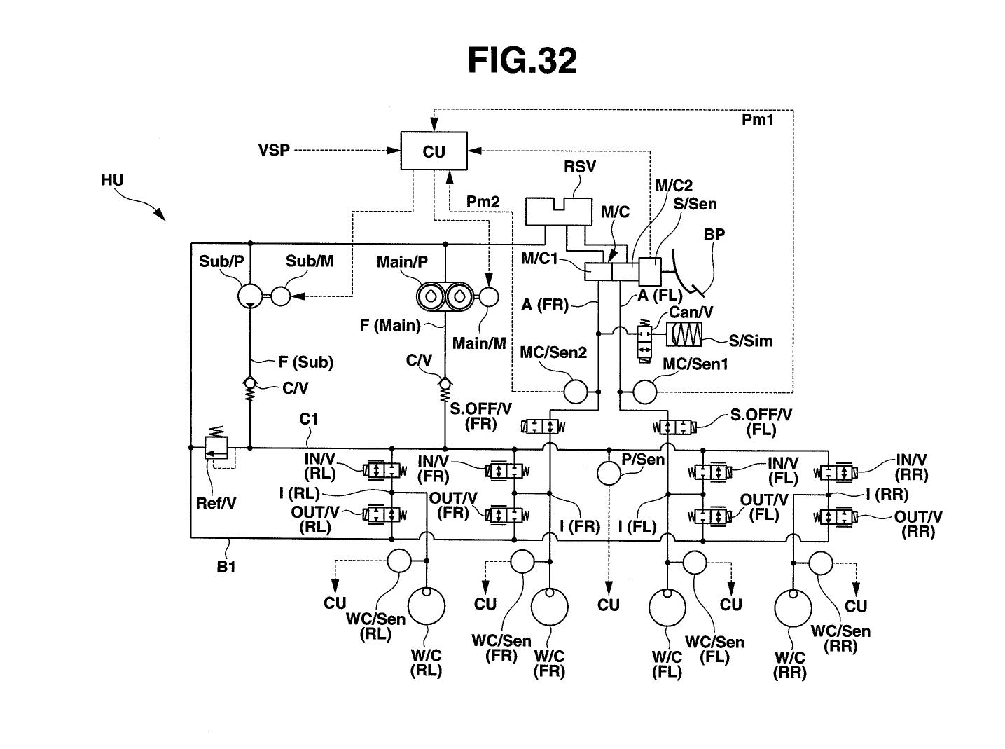

The following describes a brake control apparatus according to a sixth embodiment of the present invention with reference to FIGS. 31 and 32. The sixth embodiment is constructed based on the first embodiment. Although the brake-by-wire system of the brake control apparatus according to the first embodiment does not include the rear wheels, the brake-by-wire system of the brake control apparatus according to the sixth embodiment includes all the four wheels.

Under normal operating conditions, control unit CU controls hydraulic unit HU so as to supply hydraulic pressures to all the four wheel cylinders W/C(FL), W/C(FR), “W/C(RL)” and “W/C(RR)”. Rear left and right wheel cylinders W/C(RL) and W/C(RR) are adapted to rear left and right wheels RL and RR, respectively. Master cylinder M/C in the form of a so-called tandem type master cylinder includes a first master cylinder “M/C1” and a second master cylinder “M/C2”. Master cylinder M/C is hydraulically connected through fluid passages A(FL) and A(FR) and hydraulic unit HU to front left and right wheel cylinders W/C(FL) and W/C(FR).

Master cylinder M/C is hydraulically connected to reservoir RSV. The electromagnetic valves in hydraulic unit HU are controlled by control unit CU. A sub hydraulic pump “Sub/P” is provided in parallel with main hydraulic pump Main/P for supporting the operation of main hydraulic pump Main/P. Control unit CU drives a main electric motor “Main/M” and a sub electric motor “Sub/M” to control main hydraulic pump Main/P and sub hydraulic pump Sub/P, respectively.

Main hydraulic pump Main/P is a reversible pump, and sub hydraulic pump Sub/P is a one-way or unidirectional pump.

Shut-off valve S.OFF/V(FL), which is a normally open electromagnetic ON/OFF valve, is disposed in fluid passage A(FL) for selectively allowing or inhibiting fluid communication between second master cylinder M/C2 and front left wheel cylinder W/C(FL). Similarly, shut-off valve S.OFF/V(FR), which is a normally open electromagnetic ON/OFF valve, is disposed in fluid passage A(FR) for selectively allowing or inhibiting fluid communication between first master cylinder M/C1 and front right wheel cylinder W/C(FR).

Stroke simulator S/Sim is disposed in fluid passage A(FR) between first master cylinder M/C1 and shut-off valve S.OFF/V(FR). Stroke simulator S/Sim is hydraulically connected to fluid passage A(FR) through a cancel valve “Can/V”. Cancel valve Can/V is a normally closed electromagnetic ON/OFF valve.

Under condition that shut-off valve S.OFF/V(FR) is closed and cancel valve Can/V is opened, the brake fluid is supplied from first master cylinder M/C1 to stroke simulator S/Sim for allowing the stroke of brake pedal BP.

Main and sub hydraulic pumps Main/P and Sub/P include respective discharge ports hydraulically connected through fluid passages F(Main) and F(Sub), and though a fluid passage “C1” and nodes “I(FL)”, “I(FR)”, “I(RL)” and “I(RR)” to wheel cylinders W/C(FL), W/C(FR), W/C(RL) and W/C(RR). On the other hand, main and sub hydraulic pumps Main/P and Sub/P include respective suction ports hydraulically connected to a fluid passage “B1”.

Inlet valves IN/V(FL), IN/V(FR), “IN/V(RL)” and “IN/V(RR)”, which are normally closed linear electromagnetic valves, are provided in fluid passage C1 for selectively allowing or inhibiting fluid communication between fluid passage C1 and respective ones of wheel cylinders W/C(FL), W/C(FR), W/C(RL) and W/C(RR).

Wheel cylinders W/C(FL), W/C(FR), W/C(RL) and W/C(RR) are hydraulically connected to fluid passage B1 through nodes I(FL), I(FR), I(RL) and I(RR), respectively. Outlet valves are provided in fluid passage B1 for selectively allowing or inhibiting fluid communication between reservoir RSV and respective ones of wheel cylinders W/C(FL), W/C(FR), W/C(RL) and W/C(RR). Outlet valves OUT/V(FL) and OUT/V(FR) are normally closed linear electromagnetic valves, and other outlet valves OUT/V(RL) and OUT/V(RR) are normally opened.

Two check valves C/V are provided in fluid passages F(Main) and F(Sub) on the discharge side of main and sub hydraulic pumps Main/P and Sub/P, respectively, for preventing the brake fluid from inversely flowing from fluid passage C1 to fluid passage B1. Relief valve Ref/V is hydraulically connected between fluid passages B1 and C1 for allowing the brake fluid to flow from fluid passage C1 to fluid passage B1 when the hydraulic pressure in fluid passage C1 is above a predetermined threshold pressure value.

First master cylinder pressure sensor MC/Sen1 is disposed in fluid passage A(FL) between shut-off valve S.OFF/V(FL) and master cylinder M/C. Similarly, second master cylinder pressure sensor MC/Sen2 is disposed in fluid passage A(FR) between shut-off valve S.OFF/V(FR) and master cylinder M/C. Wheel cylinder pressure sensors WC/Sen(FL), WC/Sen(FR), “WC/Sen(RL)” and “WC/Sen(RR)” are provided at wheel cylinders W/C(FL), W/C(FR), W/C(RL) and W/C(RR), respectively. Pump discharge pressure sensor P/Sen is disposed in fluid passage C1.

Control unit CU receives data signals indicative of first measured master cylinder pressure Pm1, second measured master cylinder pressure Pm2, wheel cylinder pressures Pfl, Pfr, “Prl” and “Prr”, and stroke signal S.

On the basis of those data signals, control unit CU computes desired wheel cylinder pressures P*fl, P*fr, “P*rl” and “P*rr”, and controls main and sub electric motors Main/M and Sub/M, inlet valves IN/V(FL), IN/V(FR), IN/V(RL) and IN/V(RR), and outlet valves OUT/V(FL), OUT/V(FR), OUT/V(RL) and OUT/V(RR). Under normal operating conditions, control unit CU keeps shut-off valves S.OFF/V(FL) and S.OFF/V(FR) closed and keeps cancel valve Can/V opened.

Control unit CU compares desired wheel cylinder pressures P*fl, P*fr, P*rl and P*rr with wheel cylinder pressures Pfl, Pfr, Prl and Prr, and when judging that at least one of wheel cylinder pressures Pfl, Pfr, Prl and Prr responses abnormally to a related one of desired wheel cylinder pressures P*fl, P*fr, P*rl and P*rr, then outputs a data signal indicative of abnormality to a warning lamp “WL”. Control unit CU further receives a data signal indicative of a wheel speed “VSP”, and judges whether or not the vehicle is stationary.

Under normal operating conditions, the brake control apparatus operates generally as follows. Control unit CU computes desired wheel cylinder pressures P*fl, P*fr, P*rl and P*rr of wheel cylinders W/C(FL), W/C(FR), W/C(RL) and W/C(RR) on the basis of the degree of depression of brake pedal BP detected by stroke sensor S/Sen, while opening the cancel valve Can/V and closing the shut-off valves S.OFF/V(FL) and S.OFF/V(FR). When it is desired to increase the hydraulic pressure in hydraulic unit HU, control unit CU drives electric motor M and sub electric motor Sub/M to allow main and sub hydraulic pumps Main/P and Sub/P to pressurize fluid passage C1. On the basis of the computed desired wheel cylinder pressures P*fl, P*fr, P*rl and P*rr, control unit CU controls inlet valves IN/V(FL), IN/V(FR), IN/V(RL) and IN/V(RR) so as to supply hydraulic pressures to wheel cylinders W/C(FL), W/C(FR), W/C(RL) and W/C(RP) for producing braking efforts.

When it is desired to reduce wheel cylinder pressures Pfl, Pfr, Prl and Prr, control unit CU controls outlet valves OUT/V(FL), OUT/V(FR), OUT/V(RL) and OUT/V(RR) so as to drain the brake fluid from wheel cylinders W/C(FL), W/C(FR), W/C(RL) and W/C(RR) through fluid passage B1 to reservoir RSV.

When it is desired to hold constant wheel cylinder pressures Pfl, Pfr, Prl and Prr, control unit CU closes inlet valves IN/V(FL), IN/V(FR), IN/V(RL) and IN/V(RR) and outlet valves OUT/V(FL), OUT/V(FR), OUT/V(RL) and OUT/V(RR) so as to inhibit fluid communication among wheel cylinders W/C(FL), W/C(FR), W/C(RL) and W/C(RR), and fluid passages C1 and B1.

While the brake control apparatus is operating in manual braking mode, control unit CU controls hydraulic unit HU by allowing the shut-off valves S.OFF/V(FL) and S.OFF/V(FR) to be normally open, and allowing the front left and right inlet valves IN/V(FL) and IN/V(FP) and front left and right outlet valves OUT/V(FL) and OUT/V(FR) to be normally closed, so as to supply master cylinder pressure Pm to front left and right wheel cylinders W/C(FL) and W/C(FR). This allows to control mechanically the braking efforts.

Control unit CU is configured to perform a similar control process as in the first embodiment. The brake control apparatus according to the sixth embodiment also produces similar effects as in the first embodiment.

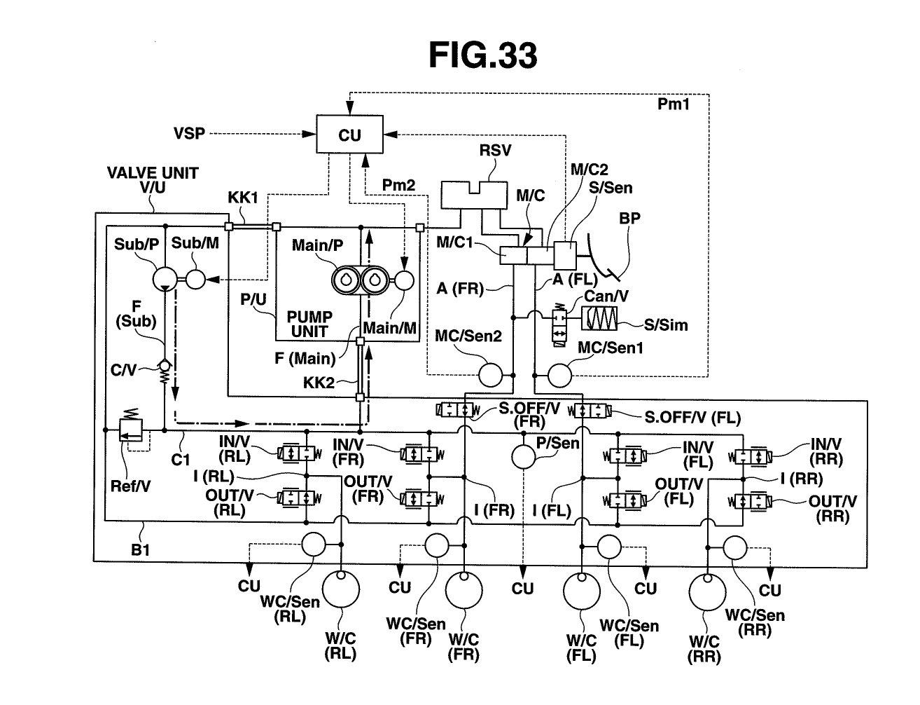

The following describes a brake control apparatus according to a modification of the sixth embodiment with reference to FIG. 33. This modification is constructed by combining the functional configuration of hydraulic unit HU according to the sixth embodiment and the control process of control unit CU according to the fifth embodiment. Specifically, control unit CU implements the prevention of overshoot of pump discharge pressure Pp by allowing the main hydraulic pump Main/P to rotate in the reverse direction.

In this modification, hydraulic unit HU is composed of a pump unit “P/U” and a valve unit “V/U”. Two steel pipes “KK1” and “KK2” are provided to connect pump unit P/U and hydraulic unit HU to each other.

Main hydraulic pump Main/P has higher power performance and larger size than sub hydraulic pump Sub/P, because main hydraulic pump Main/P is constantly employed during normal operating conditions, and sub hydraulic pump Sub/P is employed in emergency. In this example, main hydraulic pump Main/P is a reversible gear pump of high power performance and large size, and sub hydraulic pump Sub/P is a unidirectional plunger pump of small size.

If hydraulic unit HU includes a single block in which both of main hydraulic pump Main/P and sub hydraulic pump Sub/P are arranged, then the size of hydraulic unit HU is larger, and disadvantageous in mountability.

Since main hydraulic pump Main/P is arranged in pump unit P/U and sub hydraulic pump Sub/P is arranged in valve unit V/U in this embodiment, the sizes of pump unit P/U and valve unit V/U are smaller than the single block of hydraulic unit HU. Therefore, it is possible to easily mount pump unit P/U and valve unit V/U in automotive vehicles.

Since the output power of sub hydraulic pump Sub/P is lower than that of main hydraulic pump Main/P, the overshoot of the discharge pressure of sub hydraulic pump Sub/P can be easily cancelled by the reverse rotation of main hydraulic pump Main/P.

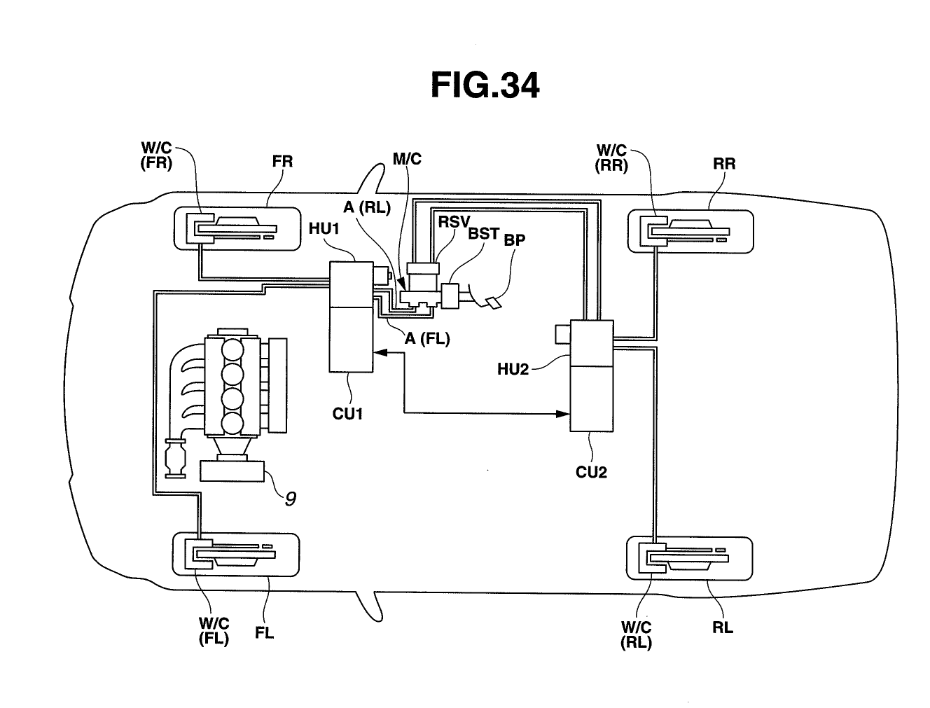

The following describes a brake control apparatus according to a seventh embodiment of the present invention with reference to FIGS. 34 to 36. Although hydraulic unit HU according to the sixth embodiment controls all the four wheels, the brake control apparatus according to the seventh embodiment includes a first hydraulic unit “HU1” for controlling the front wheels and a second hydraulic unit “HU2” for controlling the rear wheels.

According to the seventh embodiment, front left and right wheel cylinders W/C(FL) and W/C(FR) are normally pressurized by master cylinder pressure Pm (increased by a brake booster “BST”), and only when necessary, is pressurized by pump discharge pressures. The brake-by-wire system of the brake control apparatus includes only rear wheels.

As shown in FIG. 34, first and second hydraulic units HU1 and HU2 are controlled by first and second control units “CU1” and “CU2”, respectively. First and second control units CU1 and CU2 communicate and cooperate with each other to perform an integrated braking control.

Front left and right wheel cylinders W/C(FL) and W/C(FR) are hydraulically connected to master cylinder M/C through first hydraulic unit HU1, where first hydraulic unit HU1 controls front left and right wheel cylinder pressures Pfl and Pfr. Rear left and right wheel cylinders W/C(RL) and W/C(RR) are not hydraulically connected to master cylinder M/C, and are controlled by second hydraulic unit HU2.

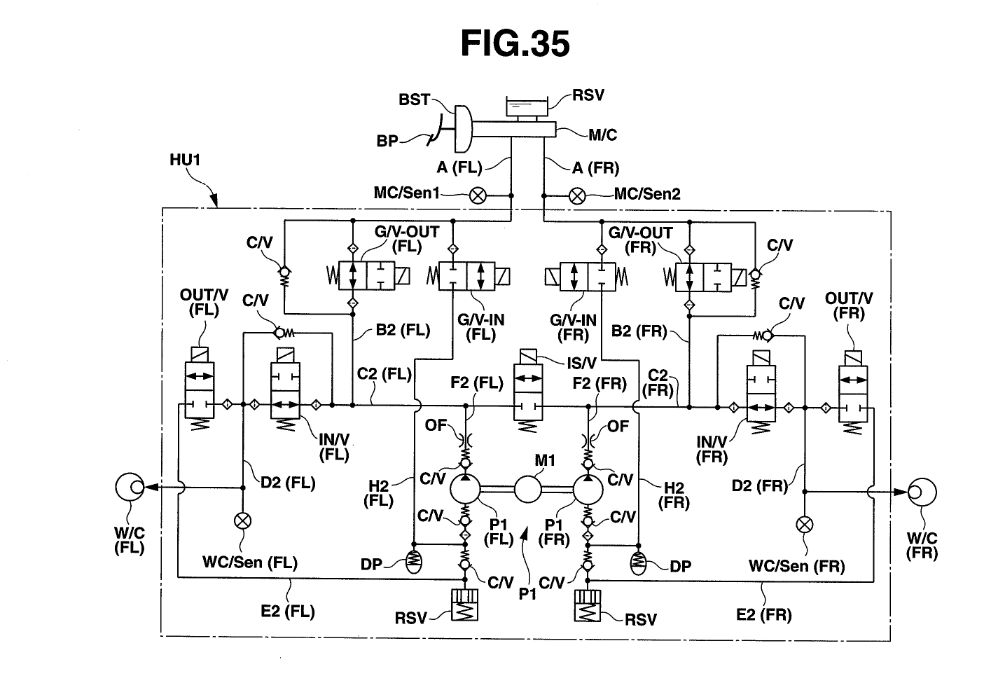

The following describes first hydraulic unit HU1 with reference to FIG. 35. The force of depressing the brake pedal BP is boosted by brake booster BST so as to pressurize master cylinder M/C. Control valves and a first electric motor M1 in first hydraulic unit HU1 are controlled according to control signals outputted from first control unit CU1.

First and second master cylinder pressure sensors MC/Sen1 and MC/Sen2 measures first and second measured master cylinder pressures Pm1 and Pm2, respectively, and then outputs data signals indicative of first and second measured master cylinder pressures Pm1 and Pm2, respectively, to first control unit CU1. Front left and right wheel cylinder pressure sensors WC/Sen(FL) and WC/Sen(FR) measures front left and right wheel cylinder pressures Pfl and Pfr, respectively, and then outputs data signals indicative of front left and right wheel cylinder pressures Pfl and Pfr, respectively, to first control unit CU1.

Master cylinder M/C of a tandem type is hydraulically connected to front left and right wheel cylinders W/C(FL) and W/C(FR) through fluid passages A(FL), A(FR), “B2(FL)”, “B2(FR)”, “C2(FL)”, “C2(FR)”, “D2(FL)”, “D2(FR)”, “E2(FL)” and “E2(FR)”.

Outlet gate valves “G/V-OUT(FL)” and “G/V-OUT(FR)” are disposed in fluid passages B2(FL) and B2(FR), respectively. Front left and right inlet valves IN/V(FL) and IN/V(FR) are disposed in fluid passages D2(FL) and D2(FR), respectively. Outlet gate valves G/V-OUT(FL) and G/V-OUT(FR), and front left and right inlet valves IN/V(FL) and IN/V(FR) are normally open electromagnetic valves. When the system is failed, then outlet gate valve G/V-OUT(FL) and front left inlet valve IN/V(FL) are controlled to be open for allowing fluid communication between master cylinder M/C and front left wheel cylinder W/C(FL). With regard to front right wheel cylinder pressure Pfr, outlet gate valve G/V-OUT(FR) and front right inlet valve IN/V(FR) are controlled similarly.

Fluid passages D2(FL) and D2(FR) are hydraulically connected to the suction port of a first hydraulic pump unit “P1” and reservoir RSV through fluid passages E2(FL) and E2(FR), respectively. Front left and right outlet valves OUT/V(FL) and OUT/V(FR), which are normally closed electromagnetic valves, are disposed in fluid passages E2(FL) and E2(FR), respectively. When opened, front left and right outlet valves OUT/V(FL) and OUT/V(FR) allow the brake fluid to flow from front left and right wheel cylinders W/C(FL) and W/C(FR), respectively, to the suction port of first hydraulic pump unit P1 and reservoir RSV.

Fluid passages A(FL) and A(FR) are hydraulically connected to the suction port of first hydraulic pump unit P1 through fluid passages “H2(FL)” and “H2(FR)”, respectively. Inlet gate valves “G/V-IN(FL)” and “G/V-IN(FR)”, which are normally closed electromagnetic valves, are disposed in fluid passages H2(FL) and H2(FR). When opened, inlet gate valves G/V-IN(FL) and G/V-IN(FR) allows the brake fluid to flow from master cylinder M/C to first hydraulic pump unit P1. A diaphragm “DP” is provided in each of fluid passages H2(FL) and H2(FR) for stabilizing the suction flow.

First hydraulic pump unit P1 includes a first hydraulic pump “P1(FL)” and a first hydraulic pump “P1(FR)” which are plunger pumps. First hydraulic pump unit P1 is driven by first electric motor M1. First hydraulic pump unit P1 includes discharge ports hydraulically connected through fluid passages “F2(FL)” and “F2(FR)” to fluid passages C2(FL) and C2(FR) for pressurizing the fluid passages C2(FL) and C2(FR). Check valves C/V are disposed on both sides of each of first hydraulic pumps P1(FL) and P1(FR). Orifices “OF” are disposed in fluid passages F2(FL) and F2(FR) on the discharge side of each of first hydraulic pumps P1(FL) and P1(FR) for reducing the level of fluctuations in the hydraulic pressures.

Fluid passages C2(FL) and C2(FR) are hydraulically connected to each other through an isolation valve “IS/V” which is a normally closed electromagnetic valve. When opened, isolation valve IS/V allows fluid communication between the discharge port of first hydraulic pump P1(FL) and the discharge port of first hydraulic pump P1(FR). When closed, isolation valve IS/V allows to supply the hydraulic pressures from first hydraulic pumps P1(FL) and P1(FR) to front left and right wheel cylinders W/C(FL) and W/C(FR) independently of each other. Therefore, it is possible to supply a fluid pressure to one of front left and right wheel cylinders W/C(FL) and W/C(FR), even when one of a system related to front left wheel cylinder W/C(FL) and a system related to front right wheel cylinder W/C(FR) is failed.

Check valves C/V are disposed in parallel to outlet gate valves G/V-OUT(FL) and G/V-OUT(FR) and front left and right inlet valves IN/V(FL) and IN/V(FR) for preventing the brake fluid from inversely flowing from front left and right wheel cylinders W/C(FL) and W/C(FR) to master cylinder M/C.

When it is desired to increase the wheel cylinder pressures under normal operating conditions, control unit CU1 opens outlet gate valves G/V-OUT(FL) and G/V-OUT(FR) and front left and right inlet valves IN/V(FL) and IN/V(FR), and closes the other valves, so as to allow master cylinder pressure Pm, which are boosted by brake booster BST, to flow from master cylinder M/C to front left and right wheel cylinders W/C(FL) and W/C(FR).

When it is desired to further increase the wheel cylinder pressures by the pump discharge pressures, control unit CU1 opens inlet gate valves G/V-IN(FL) and G/V-IN(FR) and front left and right inlet valves IN/V(FL) and IN/V(FR), closes the other valves, and drives first electric motor M1. The brake fluid supplied from master cylinder M/C flows through fluid passages H2(FL) and H2(FR), enters first hydraulic pumps P1(FL) and P1(FR). Then, first hydraulic pumps P1(FL) and P1(FR) supply the is discharge pressures to front left and right wheel cylinders W/C(FL) and W/C(FR).

When it is desired to hold the wheel cylinder pressures constant, control unit CU1 closes front left and right inlet valves IN/V(FL) and IN/V(FR) and front left and right outlet valves OUT/V(FL) and OUT/V(FR), so as to hold constant front left and right wheel cylinder pressures Pfl and Pfr.

When it is desired to reduce the wheel cylinder pressures, control unit CU1 opens front left and right outlet valves OUT/V(FL) and OUT/V(FR) so as to allow the brake fluid to flow from front left and right wheel cylinders W/C(FL) and W/C(FR) through fluid passages E2(FL) and E2(FR) to reservoir RSV. The brake fluid flows from reservoir RSV through first hydraulic pumps P1(FL) and P1(FR), fluid passages B2(FL) and B2(FR), and outlet gate valves G/V-OUT(FL) and G/V-OUT(FR) to master cylinder M/C.

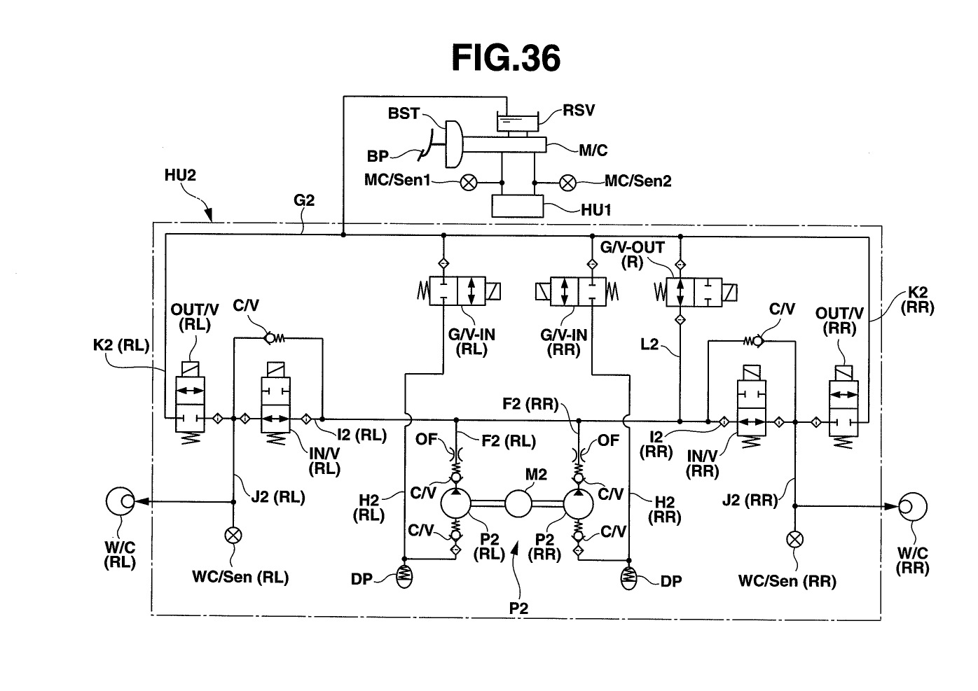

The following describes second hydraulic unit HU2 with reference to FIG. 36. Second hydraulic unit HU2 is hydraulically independent from master cylinder M/C, and serves for the brake-by-wire system for rear left and right wheels RL and RR.

Control valves and a second electric motor “M2” in second hydraulic unit HU2 are controlled according to control signals outputted from second control unit CU2. A second hydraulic pump unit “P2” is constructed similarly as first hydraulic pump unit P1. Second hydraulic pump unit P2 includes a second hydraulic pump “P2(RL)” and a second hydraulic pump “P2(RR)” which are plunger pumps. Second hydraulic pump unit P2 is driven by second electric motor M2. Check valves C/V are disposed on both sides of each of second hydraulic pumps P2(RL) and P2(RR). Orifices OF are disposed in fluid passages “F2(RL)” and “F2(RR)” on the discharge side of each of second hydraulic pumps P2(RL) and P2(RR) for reducing the level of fluctuations in the hydraulic pressure.

Reservoir RSV is hydraulically connected to fluid passage “G2”. Fluid passage G2 is hydraulically connected through fluid passage “H2(RL)” and “H2(RR)” to the suction ports of second hydraulic pump unit P2. Inlet gate valves “G/V-IN(RL)” and “G/V-IN(RR)”, which are normally closed electromagnetic valves, are disposed in fluid passages H2(RL) and H2(RR), respectively. When opened, inlet gate valves G/V-IN(RL) and G/V-IN(RR) allows fluid communication between the suction ports of second hydraulic pump unit P2 and reservoir RSV. A diaphragm DP is provided in each of fluid passages H2(RL) and H2(RR) for stabilizing the suction flow.

Second hydraulic pump unit P2 includes discharge ports hydraulically connected through fluid passages F2(RL) and F2(RR) to fluid passages “I2(RL)” and “I2(RR)”, respectively. Fluid passages I2(RL) and I2(RR) are hydraulically connected through fluid passages “J2(RL)” and “I2(RR)” to rear left and right wheel cylinders W/C(RL) and W/C(RR), respectively. Rear left and right inlet valves IN/V(RL) and IN/V(RR), which are normally open electromagnetic valves, are disposed in fluid passages I2(RL) and I2(RR), respectively.

When opened, rear left and right inlet valves IN/V(RL) and IN/V(RR) allow fluid communication between the discharge side of second hydraulic pump unit P2 and rear left and right wheel cylinders W/C(RL) and W/C(RR), respectively. Check valves C/V are disposed in parallel to rear left and right inlet valves IN/V(RL) and IN/V(RR) for preventing the operating fluid from reversely flowing from rear left and right wheel cylinders W/C(RL) and W/C(RR) to reservoir RSV.

Fluid passages I2(RL) and I2(RL) are hydraulically connected through a fluid passage “K2(RL)” to fluid passage G2. Similarly, fluid passages I2(RR) and I2(RR) are hydraulically connected through a fluid passage “K2(RR)” to fluid passage G2. Rear left and right outlet valves OUT/V(RL) and OUT/V(RR), which are normally closed electromagnetic valves, are disposed in fluid passages K2(RL) and K2(RR), respectively. When opened, rear left and right outlet valves OUT/V(RL) and OUT/V(RR) allows fluid communication between fluid passage G2 and rear left and right wheel cylinders W/C(RL) and W/C(RR), respectively. An outlet gate valve “G/V-OUT(R)”, which is a normally open electromagnetic valve, is disposed in a fluid passages “L2” hydraulically connected between fluid passages G2 and I2(RR).

When it is desired to increase the wheel cylinder pressures under normal operating conditions, control unit CU2 drives second hydraulic pump unit P2 for pressures increase, because second hydraulic unit HU2 employs no master cylinder pressure Pm. Control unit CU2 opens inlet gate valves G/V-IN(RL) and G/V-IN(RR) and rear left and right inlet valves IN/V(RL) and IN/V(RR), closes the other valves, and drives second hydraulic pump unit P2, so that the brake fluid flows from reservoir RSV through fluid passages G2 and H2(RL) and H2(RR) to second hydraulic pump unit P2. The pump discharge pressure is supplied through fluid passages I2(RL) and I2(RR) and fluid passages J2(RL) and J2(RR) to rear left and right wheel cylinders W/C(RL) and W/C(RR).

When it is desired to hold the wheel cylinder pressures constant, control unit CU2 closes rear left and right inlet valves IN/V(RL) and IN/V(RR) and rear left and right outlet valves OUT/V(RL) and OUT/V(RR), so as to hold constant rear left and right wheel cylinder pressures Prl and Prr.

When it is desired to reduce the wheel cylinder pressures, control unit CU2 opens rear left and right outlet valves OUT/V(RL) and OUT/V(RR) so as to allow the brake fluid to flow from rear left and right wheel cylinders W/C(RL) and W/C(RR) through fluid passages K2(RL) and K2(RR) and fluid passage G2 to reservoir RSV.

Control unit CU is configured to perform a similar control process as in the first embodiment. The brake control apparatus according to the seventh embodiment also produces similar effects as in the first embodiment.

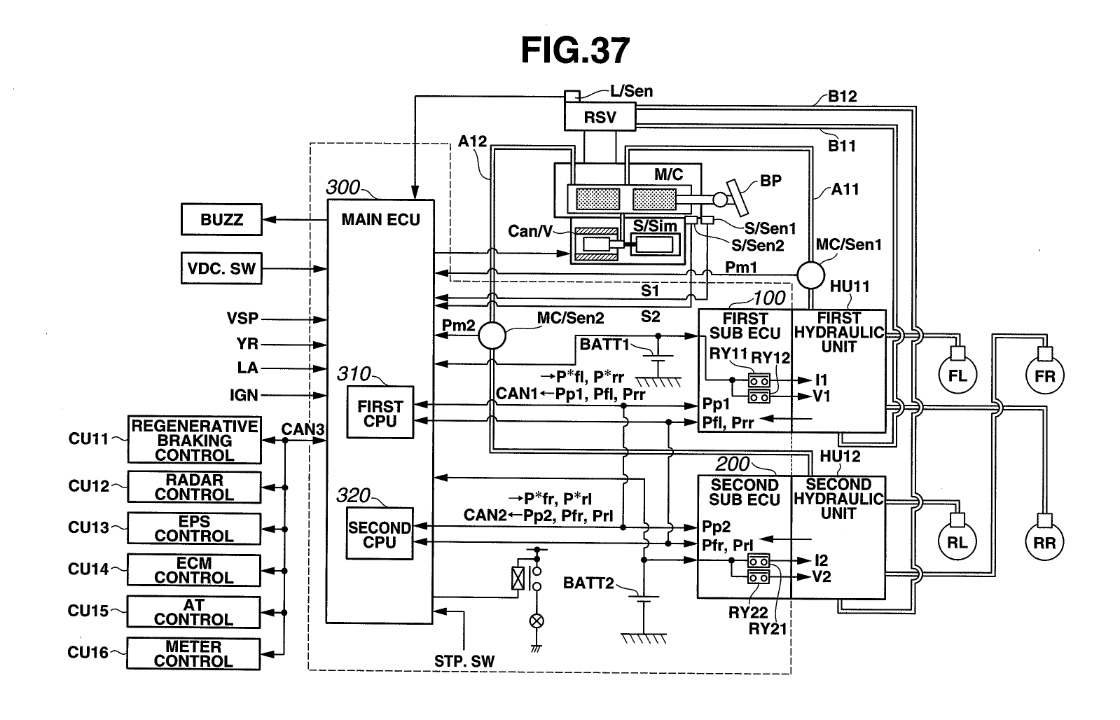

The following describes a brake control apparatus according to an eighth embodiment of the present invention with reference to FIGS. 37 to 39. Although first and second hydraulic units HU1 and HU2 according to the seventh embodiment control a set of front left and right wheels FL and FR and a set of rear left and right wheels RL and RR, respectively, first and second hydraulic units “HU11” and “HU12” according to the eighth embodiment control a set of front left and rear right wheels FL and RR and a set of front right and rear left wheels FR and RL, respectively. That is, the brake control apparatus according to the eighth embodiment is based on so-called X-pipe arrangement.

Although control unit CU has both of a function of computing desired wheel cylinder pressures, and a function of controlling actuators in the preceding embodiments, a high-level main ECU 300 according to the eighth embodiment has a function of computing desired wheel cylinder pressures, and low-level first and second sub ECUs 100 and 200 according to the eighth embodiment have functions of controlling actuators.

Under normal operating conditions, the brake control apparatus according to the eighth embodiment pressurizes all the four wheel cylinders by pump discharge pressures. Under abnormal operating conditions, the brake control apparatus supplies master cylinder pressure Pm to front left and right wheels FL and FR.

The following describes system configuration of the brake control apparatus according to the eighth embodiment with reference to FIG. 37. First and second hydraulic units HU11 and HU12 are driven by first and second sub ECUs 100 and 200 in accordance with control commands outputted from main ECU 300. Stroke simulator S/Sim, which is hydraulically connected to master cylinder M/C, applies a feedback force to brake pedal BP.

First and second hydraulic units HU11 and HU12 are hydraulically connected to master cylinder M/C through fluid passages “A11” and “A12”, respectively, and hydraulically connected to reservoir RSV through fluid passages “B11” and “B12”, respectively. First and second master cylinder pressure sensors MC/Sen1 and MC/Sen2 are provided in fluid passages A11 and A12, respectively.

Each of first and second hydraulic units HU11 and HU12 is a hydraulic actuator for generating fluid pressures independently of each other, including a hydraulic pump “P11”, “PP12”, an electric motor “M11”, “M12”, and electromagnetic valves. First hydraulic unit HU11 performs a fluid pressure control for front left and rear right wheels FL and RR, while second hydraulic unit HU12 performs a fluid pressure control for front right and rear left wheels FR and RL.

Specifically, hydraulic pumps P11 and P12, as two hydraulic sources, directly pressurize wheel cylinders W/C(FL) to W/C(RR). Since wheel cylinders W/C(FL) to W/C(RR) are pressurized directly by hydraulic pumps P11 and P12 with no accumulator, there is no possibility that a gas in such an accumulator leaks into a fluid passage under a failed condition. Hydraulic pump P11 serves for pressure increase for front left and rear right wheels FL and RR, and hydraulic pump P12 serves for pressure increase for front right and rear left wheels FR and RL, constituting so called an X-pipe arrangement.

First and second hydraulic units HU11 and HU12 are provided separately from each other. The separate provision allows one hydraulic unit to generate a braking effort, even when the other hydraulic unit is subject to leaking. However, first and second hydraulic units HU11 and HU12 are not so limited, but may be provided as a unit so as to collect electric circuit configurations at one place, shorten harnesses, etc., and thus simplify the layout.

A small number of hydraulic sources are desired for the compactness of the brake control apparatus. However, in the case of a single hydraulic source, there is no backup when the hydraulic source is failed. On the other hand, in the case of four hydraulic sources for respective wheels, it is advantageous against failures, but the device is large-sized, and difficult to control. A brake-by-wire control requires a redundant system. Such a system may diverge with an increase in the number of hydraulic sources.

Currently, brake fluid passages of vehicles are generally in the form of X-pipe arrangement in which a pair of diagonally opposite wheels (FL-RR or FR-RL) are connected to each other through a fluid passage, and each system is pressurized by a separate hydraulic source (tandem-type master cylinder, etc.). Thus, even when one pair of diagonally opposite wheels are failed, the other pair of diagonally opposite wheels can generate a braking effort while preventing the braking effort from leaning to one of the left and right sides. Therefore, the number of hydraulic sources is assumed to be two in general.

Naturally, in the case of a single hydraulic source, no X-pipe arrangement is possible. Also, in the case of three or four hydraulic sources, each pair of diagonally opposite wheels are not connected by a single hydraulic source, no X-pipe arrangement is possible.

Therefore, in order to improve anti-fail performance while employing widely-used X-pipe arrangement with no modification, the brake control apparatus according to the eighth embodiment includes two hydraulic units HU11 and HU12 having hydraulic pumps P11 and P12 as hydraulic sources.

When a vehicle is under braking, it is difficult to depend largely on the braking effort of rear wheels, because a larger load is applied to front wheels. A large braking effort of rear wheels may cause a spin.

Accordingly, in general, braking effort is distributed relatively largely to front wheels, for example, 2 part to front wheels and 1 part to rear wheels.

When a plurality of hydraulic systems are provided in a vehicle in order to enhance anti-fail performance, it is desired that the hydraulic systems have identical specifications in view of manufacturing cost. In case four hydraulic systems are provided to four wheels, respectively, two sets of hydraulic systems having different specifications are necessary in consideration of front-rear braking effort distribution as described above. This increases the total manufacturing cost. This is true for cases where three hydraulic systems are provided in a vehicle.

According to the eighth embodiment, first and second hydraulic units HU11 and HU12 in X-pipe arrangement are each configured to supply 2 part to front wheels and 1 part to rear wheels. The ratio of distribution is set by adjusting valve openings in each of first and second hydraulic units HU11 and HU12. First and second hydraulic units HU11 and HU12 are identical to each other. This is effective for reduction in manufacturing cost.

Main ECU 300 is a high-level CPU for computing desired wheel cylinder pressures P*fl to P*rr which are to be generated by first and second hydraulic units HU11 and HU12. Main ECU 300 is electrically connected to first and second power supplies “BATT1” and “BATT2” so that main ECU 300 is capable of operating when at least one of BATT1 and BATT2 is normal. Main ECU 300 is started in response to an ignition signal “IGN” or in response to a start request from other control units “CU11”, “CU12”, “CU13”, “CU14”, “CU15” and “CU16”.

First and second stroke sensors S/Sen1 and S/Sen2 outputs stroke signals S1 and S2 to main ECU 300. First and second master cylinder pressure sensors MC/Sen1 and MC/Sen2 outputs data signals indicative of master cylinder pressures Pm1 and Pm2 to main ECU 300.

Main ECU 300 receives data signals indicative of wheel speed VSP, a yaw rate YR and a vehicle longitudinal acceleration LA. Moreover, main ECU 300 receives a data signal from a fluid amount sensor L/Sen provided in reservoir RSV. Main ECU 300 judges whether or not it is possible to perform a brake-by-wire control based on hydraulic pump drive. Operation of brake pedal BP is detected based on a signal from a stop lamp switch “STP.SW”, not based on stroke signals S1 and S2 and first and second measured master cylinder pressures Pm1 and Pm2.

Main ECU 300 includes first and second CPUs 310 and 320. First and second CPUs 310 and 320 are respectively electrically connected to first and second sub ECUs 100 and 200 through CAN communication lines CAN1 and CAN2. First and second sub ECUs 100 and 200 output data signals indicative of hydraulic pump discharge pressures Pp1 and Pp2, and actual wheel cylinder pressures Pfl to Prr, to first and second CPUs 310 and 320. CAN communication lines CAN1 and CAN2 are electrically connected to each other for bidirectional communication, and are each in the form of a redundant system for backup.

On the basis of the inputted stroke signals S1 and S2, first and second measured master cylinder pressures Pm1 and Pm2, and actual wheel cylinder pressures Pfl to Prr, first and second CPUs 310 and 320 compute desired wheel cylinder pressures P*fl to P*rr, and then output them to sub ECUs 100 and 200 through CAN communication lines CAN1 and CAN2.

Alternatively, desired wheel cylinder pressures P*fl to P*rr for first and second hydraulic units HU11 and HU12 may be computed only by first CPU 310, while second CPU 320 may serve as a backup for first CPU 310.

Main ECU 300 starts sub ECUs 100 and 200 by issuing respective starting signals to first and second sub ECUs 100 and 200 through CAN communication lines CAN1 and CAN2. Main ECU 300 may be configured to issue a single starting signal to first and second sub ECUs 100 and 200 so that both of first and second sub ECUs 100 and 200 start up. First and second sub ECUs 100 and 200 may be started by an ignition switch.

During vehicle behavior controls such as ABS (control of increase and reduction in braking effort for is preventing vehicle wheels from locking up), VDC (control of increase and reduction in braking effort for preventing side slips under disturbance of vehicle behavior), and TCS (control of preventing driving wheels from slipping), main ECU 300 computes desired wheel cylinder pressures P*fl to P*rr also on the basis of wheel speed VSP, yaw rate YR and vehicle longitudinal acceleration LA. During the VDC control, a buzzer “BUZZ” warns a driver. A driver can operate a VDC switch “VDC.SW” to turn on or off the VDC control.

Main ECU 300 is electrically connected to other control units CU11, CU12, CU13, CU14, CU15 and CU16 through CAN communication line CAN3 so that main ECU 300 performs a cooperative control. Regenerative braking control unit CU11 regenerates braking effort into electric energy. Radar control unit CU12 controls vehicle-to-vehicle distance. EPS control unit CU13 is a control unit of an electric power steering system.

ECM control unit CU14 is a control unit of an engine. AT control unit CU15 is a control unit of an automatic transmission. Meter control unit CU16 controls meters. Main ECU 300 relays a data signal indicative of wheel speed VSP through CAN communication line CAN3 to ECM control unit CU14, AT control unit CU15 and meter control unit CU16.

ECUs 100, 200 and 300 receive electric power from first and second power supplies BATT1 and BATT2. First power supply BATT1 is electrically connected to main ECU 300 and first sub ECU 100. Second power supply BATT2 is electrically connected to main ECU 300 and is second sub ECU 200.

First and second sub ECUs 100 and 200 are formed integrally with first and second hydraulic units HU11 and HU12, respectively. Alternatively, first and second sub ECUs 100 and 200 may be formed separately from first and second hydraulic units HU11 and HU12, respectively, in order to conform to the layout of the vehicle.

First and second sub ECUs 100 and 200 receive data signals indicative of desired wheel cylinder pressures P*fl to P*rr from main ECU 300, and receive data signals indicative of hydraulic pump discharge pressures Pp1 and Pp2 of first and second hydraulic pumps P11 and P12 and actual wheel cylinder pressures Pfl and Prr, and Pfr and Prl from first and second hydraulic units HU11 and HU12.

First and second sub ECUs 100 and 200 perform fluid pressure control by operating hydraulic pumps P11 and P12, electric motors M11 and M12, and the electromagnetic valves in first and second hydraulic units HU11 and HU12, based on the inputted pump discharge pressures Pp1 and Pp2 and actual wheel cylinder pressures Pfl to Prr, in order to attain desired wheel cylinder pressures P*fl to P*rr.

Until the current values of desired wheel cylinder pressures P*fl to P*rr are replaced by new values of desired wheel cylinder pressures P*fl to P*rr, first and second sub ECUs 100 and 200 perform a servo control of converging wheel cylinder pressures Pfl, Pfr, Prl and Prr to the current values of desired wheel cylinder pressures P*fl, P*fr, P*rl and P*rr.

First and second sub ECUs 100 and 200 convert the electric power supplied from power supplies BATT1 and BATT2 into valve drive currents I1 and I2 and motor drive currents Im1 and Im2 for first and second hydraulic units HU11 and HU12, and then outputs them to first and second hydraulic units HU11 and HU12 through relays RY11 and RY12, and relays RY21 and RY22, respectively.

Main ECU 300 according to the eighth embodiment computes desired wheel cylinder pressures P*fl, P*fr, P*rl and P*rr, but does not control first and second hydraulic units HU1 and HU2. However, it is considered that main ECU 300 is configured to compute desired wheel cylinder pressures P*fl, P*fr, P*rl and P*rr, and directly control first and second hydraulic units HU1 and HU2. In such a case, main ECU 300 cooperates with the other control units CU11, CU12, CU13, CU14, CU15 and CU16 through CAN communication line CAN3 to output drive commands to first and second hydraulic units HU11 and HU12. Thus, main ECU 300 outputs drive commands to first and second hydraulic units HU11 and HU12 after completion of signal communication through CAN communication line CAN3 and computation in control units CU11, CU12, CU13, CU14, CU15 and CU16. Therefore, if signal communication through CAN communication line CAN3 and computation in control units CU11, CU12, CU13, CU14, CU15 and CU16 take much time, the braking control is subject to delays. Increase in communication speed of CAN communication line CAN3 tends to increase the cost thereof, and to affect adversely the anti-fail performance against noise.

For the reasons described above, main ECU 300 according to the eighth embodiment serves only to compute desired wheel cylinder pressures P*fl to P*rr for first and second hydraulic units HU11 and HU12, while the drive control of first and second hydraulic units HU11 and HU12 are performed by first and second sub ECUs 100 and 200 having the servo control system. Thus, first and second sub ECUs 100 and 200 handle the control of first and second hydraulic units HU11 and HU12, while main ECU 300 handles cooperative control between control units CU11, CU12, CU13, CU14, CU15 and CU16. This is effective for bring operation of first and second hydraulic units HU11 and HU12 under no influence of speed of signal communication through CAN communication line CAN3 and computation in control units CU11, CU12, CU13, CU14, CU15 and CU16.

According to the foregoing configuration in which main ECU 300 cooperates with first and second sub ECUs 100 and 200, even when there are added various units such as a regeneration cooperative brake system, a vehicle integrated control, and an ITS, which are in general necessary for hybrid vehicles and fuel cell vehicles, the brake control system is controlled independently of other controls systems so as to ensure the responsiveness of the brake control in conformance with these units. The foregoing configuration in which main ECU 300 cooperates with first and second sub ECUs 100 and 200 is advantageous, especially because such a brake-by-wire system as described in the present embodiments requires an elaborate control based on the amount of operation of a brake pedal during normal braking that is frequently employed.

Stroke simulator S/Sim is mounted in master cylinder M/C for generating a feedback force to brake pedal BP. Master cylinder M/C includes cancel valve Can/V for selectively allowing or inhibiting fluid communication between master cylinder M/C and stroke simulator S/Sim. Cancel valve Can/V is opened or closed by main ECU 300. When the brake-by-wire system is terminated, or when sub ECUs 100 and 200 are failed, then cancel valve Can/V is quickly closed so that the brake control apparatus enters manual braking mode. Master cylinder M/C includes first and second stroke sensors S/Sen1 and S/Sen2 for measuring the stroke of brake pedal BP, and outputting stroke signals S1 and S2 to main ECU 300.

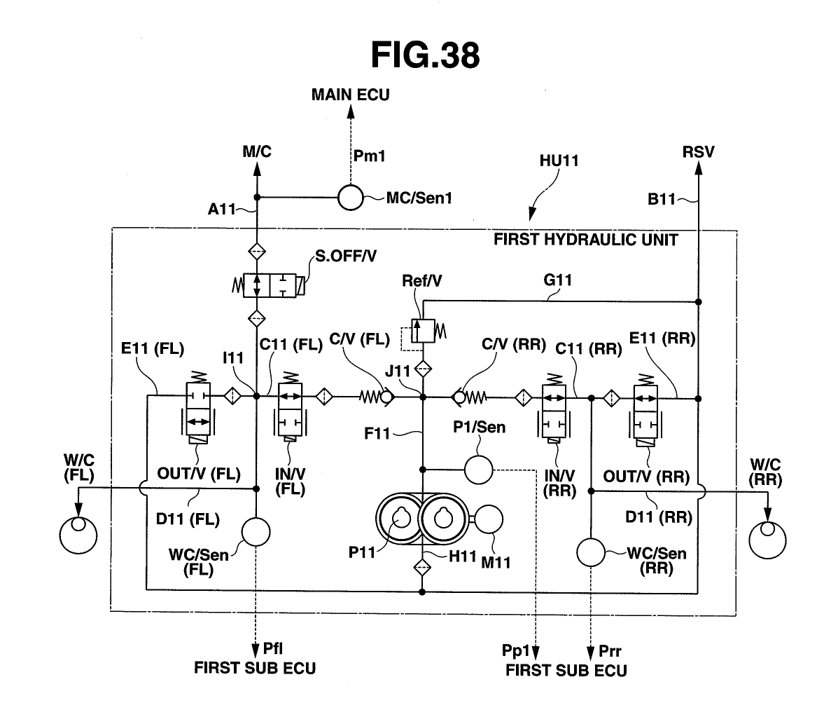

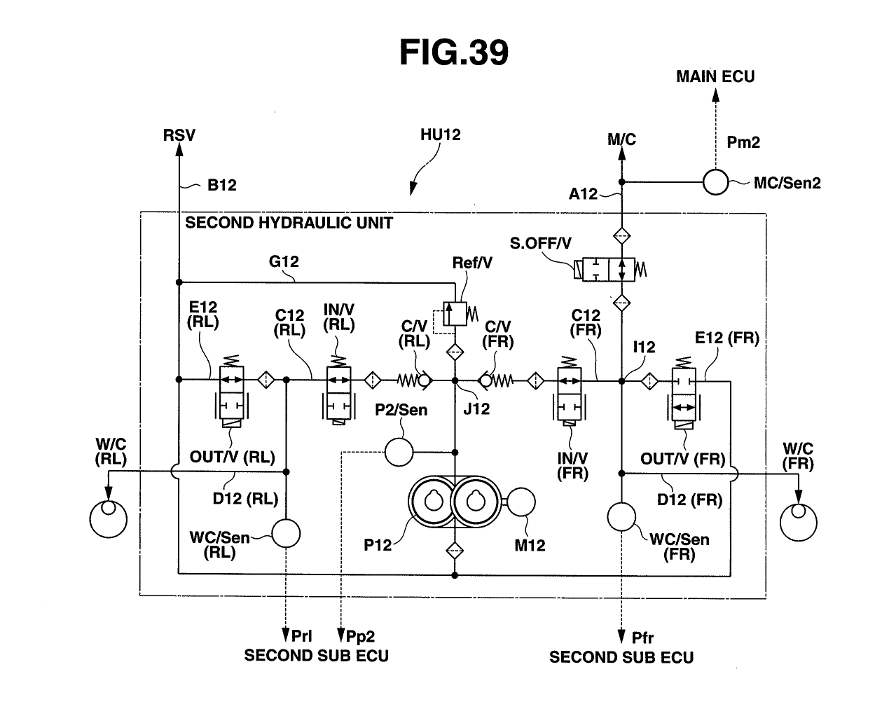

The following describes first and second hydraulic units HU11 and HU12 in detail with reference to FIGS. 38 and 39. First hydraulic unit HU11 includes a shut-off valve “S.OFF/V”, front left and rear right inlet valves IN/V(FL) and IN/V(RR) and front left and rear right outlet valves OUT/V(FL) and OUT/V(RR), hydraulic pump P11, and electric motor M11. First and second hydraulic units HU11 and HU12 are constructed by adjusting the cross-sectional flow area of fluid passages and valves so that the level of front left and right wheel cylinder pressures Pfl and Pfr is generally twice the level of rear left and right wheel cylinder pressures Prl and Prr.

Hydraulic pump P11 includes a discharge port hydraulically connected through fluid passages “C11(FL)” and “C11(RR)” to front left and rear right wheel cylinders W/C(FL) and W/C(RR), and a suction port hydraulically connected through fluid passage B11 to reservoir RSV. Fluid passages C11(FL) and C11(RR) are hydraulically connected to fluid passage B11 through fluid passages “E11(FL)” and “E11(RR)”, respectively.

A node “I11” between fluid passages C11(FL) and E11(FL) is hydraulically connected to master cylinder M/C through fluid passage All. A node “J11” between fluid passages C11(FL) and C11(RR) is hydraulically connected to fluid passage B11 through a fluid passage “G11”.

Shut-off valve S.OFF/V, which is a normally open electromagnetic valve, is disposed in fluid passage All for selectively allowing or inhibiting fluid communication between master cylinder M/C and node Ill.

Front left and rear right inlet valves IN/V(FL) and IN/V(RR) are normally open linear electromagnetic valves disposed in fluid passages C11(FL) and C11(RR), respectively, for continuously regulating the hydraulic pressures supplied from hydraulic pump P11, and supplying the regulated hydraulic pressures to front left and rear right wheel cylinders W/C(FL) and W/C(RR). Check valves C/V(FL) and “C/V(RR)” are provided in fluid passages C11(FL) and C11(RR) for preventing the brake fluid from inversely flowing to hydraulic pump P11.

Front left and rear right outlet valves OUT/V(FL) and OUT/V(RR) are provided in fluid passages Ell(FL) and Ell(RR), respectively. Front left outlet valve OUT/V(FL) is a normally closed linear electromagnetic valve, while rear right outlet valve OUT/V(RR) is a normally open linear electromagnetic valve. Relief valve Ref/V is provided in fluid passage G11.

First master cylinder pressure sensor MC/Sen1 is provided in fluid passage A11 between first hydraulic unit HU11 and master cylinder M/C, for outputting a data signal indicative of first measured master cylinder pressure Pm1 to main ECU 300. In first hydraulic unit HU11, front left and rear right wheel cylinder pressure sensors WC/Sen(FL) and WC/Sen(RR) are provided in fluid passages C11(FL) and C11(RR), respectively, for measuring the internal pressures of wheel cylinders W/C(FL) and W/C(RR), and outputting data signals indicative of measured front left and rear right wheel cylinder pressures Pfl and Prr, respectively, to first sub ECU 100. A first pump discharge pressure “P1/Sen” is provided on the discharge side of first hydraulic pump P11, for outputting a data signal indicative of measured first pump discharge pressure Pp1 to first sub ECU 100.

When it is desired to increase the wheel cylinder pressures under normal operating conditions, then first sub ECU 100 closes shut-off valve S.OFF/V, closes front left and rear right outlet valves OUT/V(FL) and OUT/V(RR), and drives first motor M11. Accordingly, first motor M11 drives first hydraulic pump P11 so as to supply a discharge pressure through fluid passage F11 to fluid passages C11(FL) and C11(RR), and front left and rear right inlet valves IN/V(FL) and IN/V(RR) control the fluid pressures and supply them to front left and rear right wheel cylinders W/C(FL) and W/C(RR), so as to increase the wheel cylinder pressures.

When it is desired to reduce the wheel cylinder pressures under normal operating conditions, then first sub ECU 100 closes inlet valves IN/V(FL) and IN/V(RR), and opens outlet valves OUT/V(FL) and OUT/V(RR), for draining the brake fluid from front left and rear right wheel cylinders W/C(FL) and W/C(RR) to reservoir RSV, so as to reduce the wheel cylinder pressures.

When it is desired to hold constant the wheel cylinder pressures under normal operating conditions, then first sub ECU 100 closes all of front left and rear right inlet valves IN/V(FL) and IN/V(RR) and front left and rear right outlet valves OUT/V(FL) and OUT/V(RR) so as to hold constant the wheel cylinder pressures.

When the brake control apparatus is operating in manual braking mode, for example, when the brake-by-wire system is failed, then shut-off valve S.OFF/V is opened, and front left and rear right inlet valves IN/V(FL) and IN/V(RR) are opened. Because of check valve F/V(FL), master cylinder pressure Pm is not supplied to rear right wheel cylinder W/C(RR). On the other hand, front left outlet valve OUT/V(FL) is de-energized to be closed so that master cylinder pressure Pm is applied to front left wheel cylinder W/C(FL). Thus, master cylinder pressure Pm, which is increased by a driver's pedal depressing force, is applied to front left wheel cylinder W/C(FL), allowing manual braking.

It is alternatively considered that manual braking is applied to rear right wheel RR. In such a case, the load to depression of the driver is relatively large, because the wheel cylinder pressure of both of front left and rear right wheels FL and RR are implemented by the pedal depressing force. Accordingly, first hydraulic unit HU11 according to the eighth embodiment applies manual braking only to front left wheel FL, because front left wheel FL is subject to a larger load from a road, and thereby capable of generating a larger braking effort. On the other hand, rear right outlet valve OUT/V(RR) is implemented by a normally open valve so that when the brake-by-wire system is failed, rear right outlet valve OUT/V(RR) quickly drains the remaining hydraulic pressure of rear right wheel cylinder W/C(RR) so as to prevent rear right wheel RR from locking up.

Second hydraulic unit HU12 has a similar circuit configuration as shown in FIG. 39, and performs a similar control as first hydraulic unit HU11. In second hydraulic unit HU12, front right outlet valve OUT/V(FR) is implemented by a normally closed valve, and rear left outlet valve OUT/V(RL) is implemented by a normally open valve, so that manual braking is applied only to front right wheel FR when the brake-by-wire system is failed.

Main ECU 300 is configured to perform a similar control process as in the first embodiment. The brake control apparatus according to the eighth embodiment also produces similar effects as in the first embodiment.

If first and second hydraulic units HU11 and HU12 are provided separately from each other, one of first and second hydraulic units HU11 and HU12 is available for producing braking efforts even when the other of first and second hydraulic units HU11 and HU12 are failed. Conversely, if first and second hydraulic units HU11 and HU12 are provided as a unit, it is possible to collect electric circuit configurations at one place, shorten harnesses, etc., and thus simplify the layout.

As described above, first and second hydraulic units HU11 and HU12 include first and second power supplies BATT1 and BATT2, respectively. According to this construction, one of first and second hydraulic units HU11 and HU12 is available for producing braking efforts even when one of first and second power supplies BATT1 and BATT2 is failed.

This application is based on a prior Japanese Patent Application No. 2007-69674 filed on Mar. 17, 2007. The entire contents of this Japanese Patent Application No. 2007-69674 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
a wheel cylinder adapted to a wheel of a vehicle;
a pump arranged to pressurize a brake fluid in the wheel cylinder;
an electric motor arranged to drive the pump; and
a controller configured to operate the electric motor so as to conform an internal pressure of the wheel cylinder to a desired internal pressure of the wheel cylinder,
the controller being configured to produce a torque applied to the electric motor in a first rotational direction, while the pump is stopping from a state in which the electric motor is rotating in a second rotational direction opposite to the first rotational direction so as to allow the pump to pressurize the brake fluid in the wheel cylinder.

2. The brake control apparatus as claimed in claim 1, wherein the controller is configured to apply a positive torque current to the electric motor while producing a torque applied to the electric motor in the second rotational direction, and to apply a negative torque current to the electric motor while producing a torque applied to the electric motor in the first rotational direction.

3. The brake control apparatus as claimed in claim 2, wherein the electric motor is a brushless motor.

4. The brake control apparatus as claimed in claim 3, wherein the controller is configured to set the desired internal pressure in such a manner that the desired internal pressure changes stepwise with respect to time.

5. The brake control apparatus as claimed in claim 1, further comprising:
a second wheel cylinder adapted to a second wheel of the vehicle;
a first fluid passage hydraulically connected to a discharge port of the pump; and
branch fluid passages branched from the first fluid passage and hydraulically connected to respective ones of the wheel cylinders.

6. The brake control apparatus as claimed in claim 5, wherein the controller is configured to apply a positive torque current to the electric motor while producing a torque applied to the electric motor in the second rotational direction, and to apply a negative torque current to the electric motor while producing a torque applied to the electric motor in the first rotational direction.

7. The brake control apparatus as claimed in claim 6, wherein the electric motor is a brushless motor, and the controller is configured to set the desired internal pressure in such a manner that the desired internal pressure
changes stepwise with respect to time.

8. A brake control apparatus comprising:
a wheel cylinder adapted to a wheel of a vehicle;
a pump arranged to pressurize a brake fluid in the wheel cylinder;
an electric motor arranged to drive the pump; and
a controller configured to operate the electric motor so as to conform an internal pressure of the wheel cylinder to a desired internal pressure of the wheel cylinder,
the controller being configured to produce a torque applied to the electric motor in a first rotational direction, while carrying out a transition from a first operating state to a second operating state, the first operating state being an operating state that the electric motor is rotating in a second rotational direction opposite to the first rotational direction so as to allow the pump to increase the internal pressure of the wheel cylinder at a first rate of change with respect to time, the second operating state being an operating state that the electric motor is rotating in the second rotational direction so as to allow the pump to increase the internal pressure of the wheel cylinder at a second rate of change with respect to time, the second rate being lower than the first rate.

9. The brake control apparatus as claimed in claim 8, wherein the controller is configured to apply a positive torque current to the electric motor while producing a torque applied to the electric motor in the second rotational direction, and to apply a negative torque current to the electric motor while producing a torque applied to the electric motor in the first rotational direction.

10. The brake control apparatus as claimed in claim 9, wherein the electric motor is a brushless motor.

11. The brake control apparatus as claimed in claim 9, wherein the controller is configured to set the desired internal pressure in such a manner that the desired internal pressure changes stepwise with respect to time.

12. The brake control apparatus as claimed in claim 8, further comprising:
a second wheel cylinder adapted to a second wheel of the vehicle;
a first fluid passage hydraulically connected to a discharge port of the pump; and
branch fluid passages branched from the first fluid passage and hydraulically connected to respective ones of the wheel cylinders.

13. The brake control apparatus as claimed in claim 12, wherein the controller is configured to apply a positive torque current to the electric motor while producing a torque applied to the electric motor in the second rotational direction, and to apply a negative torque current to the electric motor while producing a torque applied to the electric motor in the first rotational direction.

14. The brake control apparatus as claimed in claim 13, wherein the electric motor is a brushless motor, and the controller is configured to set the desired internal pressure in such a manner that the desired internal pressure changes stepwise with respect to time.

15. A brake control apparatus comprising:
a wheel cylinder adapted to a wheel of a vehicle;
a pump arranged to pressurize a brake fluid in the wheel cylinder;
an electric motor arranged to drive the pump;
a pressure-regulator arranged to regulate an internal pressure of the wheel cylinder; and
a controller configured to operate the electric motor so as to conform the internal pressure of the wheel cylinder to a desired internal pressure of the wheel cylinder,
the controller being configured to reduce the internal pressure of the wheel cylinder by the pressure-regulator, while the electric motor is rotating so as to allow the pump to pressurize the brake fluid in the wheel cylinder.

16. The brake control apparatus as claimed in claim 15, wherein:
the pressure-regulator includes:
a reservoir; and
a pressure-reducing valve arranged in a fluid passage connected between the wheel cylinder and the reservoir for regulating fluid communication therebetween; and
the controller is configured to implement the reduction of the internal pressure of the wheel cylinder by Opening the pressure-reducing valve so as to allow fluid communication between the wheel cylinder and the reservoir.

17. The brake control apparatus as claimed in claim 15, wherein:
the pump is a main pump;
the pressure-regulator includes a second pump arranged in parallel with the main pump; and
the controller is configured to implement the reduction of the internal pressure of the wheel cylinder by allowing the second pump to reduce the internal pressure of the wheel cylinder.

18. The brake control apparatus as claimed in claim 15, wherein:
the pressure-regulator includes:
a pressure-increasing valve disposed in a fluid passage connected between the pump and the wheel cylinder for regulating fluid communication therebetween; and
a linear control valve disposed in a fluid passage connected between the pump and the pressure-increasing valve for regulating fluid communication therebetween; and
the controller is configured to implement the reduction of the internal pressure of the wheel cylinder by reducing an opening of the linear control valve so as to restrict fluid communication between the pump and the pressure-increasing valve.

19. The brake control apparatus as claimed in claim 15, wherein:
the pressure-regulator includes:
a pressure-increasing valve disposed in a first fluid passage connected between the pump and the wheel cylinder for regulating fluid communication therebetween; and
a linear control valve disposed in a second fluid passage connected between a portion of the first fluid passage and a low-pressure section for regulating fluid communication therebetween, the portion being located between the pump and the pressure-increasing valve; and
the controller is configured to implement the reduction of the internal pressure of the wheel cylinder by opening the linear control valve so as to allow fluid communication between the portion of the first fluid passage and the low-pressure section.

20. A brake control apparatus comprising:
a wheel cylinder adapted to a wheel of a vehicle;
a pump arranged to pressurize a brake fluid in the wheel cylinder;
an electric motor arranged to drive the pump; and
a controller configured to operate the electric motor so as to conform an internal pressure of the wheel cylinder to a desired internal pressure of the wheel cylinder,
the controller being configured to produce a torque applied to the electric motor in a first rotational direction, while carrying out a transition from a first operating state to a second operating state, the first operating state being an operating state that the electric motor is rotating in a second rotational direction opposite to the first rotational direction so as to allow the pump to pressurize the brake fluid in the wheel cylinder, the second operating state being an operating state that a discharge pressure of the pump is lower than in the first operating state.

21. A process of controlling a brake control apparatus including: a wheel cylinder adapted to a wheel of a vehicle; a pump arranged to pressurize a brake fluid in the wheel cylinder; and an electric motor arranged to drive the pump, the process comprising:
operating the electric motor so as to conform an internal pressure of the wheel cylinder to a desired internal pressure of the wheel cylinder; and
producing a torque applied to the electric motor in a first rotational direction, while the pump is stopping from a state in which the electric motor is rotating in a second rotational direction opposite to the first rotational direction so as to allow the pump to pressurize the brake fluid in the wheel cylinder.
